(19) United States
(12) Patent Application Publication
(10) Pub. No.: US 2014/0025478 A1
(43) Pub. Date: Jan. 23, 2014

(54) MEASURING INFLUENCE IN A SOCIAL NETWORK

(71) Applicant: MAVEN ANALYTICS INC., (US)

(72) Inventors: Tim Mischuk, Burlington (CA); John Whalen, Burlington (CA); Rick Lambrick, Burlington (CA)

(21) Appl. No.: 13/828,903

(22) Filed: Mar. 14, 2013

Related U.S. Application Data
(60) Provisional application No. 61/672,675, filed on Jul. 17, 2012.

(51) Int. Cl. G06Q 30/02; G06Q 50/00

(52) U.S. Cl. CPC G06Q 30/0242; G06Q 50/01
USPC 705/14.41

(57) ABSTRACT

Measuring influence in social networks, in which a marketing message related to a good or service has been distributed to one or more influencers. An agreement to allow tracking of the influencer's sharing of the marketing message is made. Also, after receiving the agreement to allow tracking of the influencer's sharing of the marketing message, sharing of the marketing message is enabled in a manner that enables tracking of actions taken by users to which the marketing message is shared. Sharing of the marketing message by the influencer is tracked and actions related to the marketing message taken by users to which the message was shared by the influencer are tracked. Data descriptive of an influence of the influencer related to the marketing message is stored and output based on the stored data is provided.

### CROSS REFERENCE TO RELATED APPLICATIONS

The present application claims the benefit of U.S. Provisional Application No. 61/672,675, filed Jul. 17, 2012, which is incorporated herein by reference in its entirety for all purposes.

### TECHNICAL FIELD

This disclosure relates to measuring influence in social networks.

### BACKGROUND

Social networking environments allow the sharing of social and personal information amongst friends and contacts within an individual's social network. In the commerce industry, the typical method of offer sharing uses a distribution method with relatively low percentages of publicizing or exposing an offer at a typical high cost. Enabling a social networking environment for the distribution of an offer may result in a more economical and effective method due to each receiver of an offer already having a friends or contact list present.

People have had a measure of influence over the purchase of products and services for generations. Over the past several years, conversations have become digital (e.g., digital conversations may include posts on eMail, Facebook, Twitter, Google, Instagram, and other leading digital tools). With the rise and acceptance of social media, the level of digital conversations has increased. These digital conversations may be measured in the millions of conversations per minute.

Digital conversations may be classified in two groups: a) public conversations where the user provides legal access to view and access their discussion, and b) private conversations where the discussions or posts are private or in a private framework (e.g., Facebook permits both private and public delivery of posts).

The level of digital engagement online has increased dramatically (e.g., digital engagement on sites such as the web, social media, game platforms, and mobile apps). The engagement may last several minutes to hours depending on the type of activity or engagement. Often, the user is engaged with a brand or product or game title. As part of the engagement, the user may operate anonymously or, if engagement builds, may be asked to opt-in to the engagement.

As privacy issues have increased, so have the requirements for a legal opt-in to a program accompanied by a privacy statement. An opt-in may provide rights to the product provider that enables access to user name, email, phone number, address and other personal profile elements with associated rights. Often, the user provides these profile details to continue engagement and derive the associated benefits of the service or product. In most countries, online opt-ins, have increased, thereby giving companies much needed access to user profiles to market directly to potential and existing customers.

The explosion of data often termed ‘Big Data’ is expanding within organisations at relatively high rates. Data includes not only product and sales data, but marketing and consumer profile information. Big data may be accessed from datasets growing so large that they become awkward to work with using existing database management tools. Difficulties may include capture, storage, search, sharing, analytics, and visualizing. However, the benefits of working with larger datasets may allow analysts to spot marketing trends, prevent diseases, combat crime and understand products trends.

### SUMMARY

In one aspect, a system includes at least one processor and at least one computer-readable medium coupled to the at least one processor having stored thereon instructions which, when executed by the at least one processor, causes the at least one processor to perform operations. The operations include distributing, to an influencer, a marketing message related to a good or service and receiving, from the influencer, an agreement to allow tracking of the influencer's sharing of the marketing message. The operations also include, after receiving the agreement to allow tracking of the influencer's sharing of the marketing message, enabling sharing of the marketing message in a manner that enables tracking of actions taken by users to which the marketing message is shared and tracking sharing of the marketing message by the influencer. The operations further include tracking actions related to the marketing message taken by users to which the message was shared by the influencer, storing data descriptive of an influence of the influencer related to the marketing message, and providing output based on the stored data. In another aspect, a method may include one or more of the operations described above. In yet another aspect, a computer-readable storage medium may be operable to cause a processor to perform one or more of the operations described above.

Implementations may include one or more of the following features. For example, the operations may include validating the influencer to ensure the influencer opts in and agrees to corporate and governmental privacy statements. In this example, the operations may include presenting, to the influencer, an inducement to encourage the influencer to opt in and agree to the corporate and governmental privacy statements. Further, in this example, the operations may include presenting, to the influencer, at least one of a free product, a leaderboard score, and a prize in exchange for opting in and agreeing to the corporate and governmental privacy statements.

In addition, the operations may include enabling sharing of the marketing message through at least one of a social network, a text message, an instant message, and an electronic mail message. The operations also may include determining a message identifier for the marketing message, determining an influencer identifier for the influencer, and generating a sharing identifier based on the message identifier and the influencer identifier. The operations further may include embedding the sharing identifier in data that transmits with the marketing message in sharing the marketing message and enabling the influencer to share the marketing message with the embedded sharing identifier.

In some examples, the operations may include dynamically generating a unique uniform resource locator (URL) that includes the message identifier and the influencer identifier. In these examples, the operations may include placing the dynamically-generated unique URL in the marketing message.

In some implementations, the operations may include receiving, over a network, an indication of sharing of the marketing message by the influencer and tracking sharing of the marketing message by the influencer based on receiving the indication of sharing of the marketing message by the influencer. In these implementations, the operations may include receiving, over a network from a social networking platform, an indication that the influencer shared the marketing message within the social networking platform and an indication of one or more users of the social networking platform to which the influencer shared the marketing message and tracking sharing of the marketing message by the influencer based on receiving the indication that the influencer shared the marketing message within the social networking platform and the indication of the one or more users of the social networking platform to which the influencer shared the marketing message.

In some examples, the operations may include detecting an action of a user related to the marketing message and accessing data descriptive of one or more sharing events that resulted in the user receiving the marketing message. In these examples, the operations may include linking the one or more sharing events with the detected action of the user and tracking the detected action of the user in association with the one or more sharing events and the marketing message. Further, in these examples, the operations may include detecting at least one of a view of the marketing message, an opt-in related to the marketing message, and a purchase related to the marketing message and tracking the at least one of the view of the marketing message, the opt-in related to the marketing message, and the purchase related to the marketing message in association with the one or more sharing events and the marketing message.

In addition, the operations may include receiving, over a network from a merchant server of a merchant, an indication that the user made, from the merchant, a purchase related to the marketing message and tracking the purchase related to the marketing message in association with the one or more sharing events and the marketing message. The operations also may include accessing, from electronic storage on a device of the user, a data file that records the one or more sharing events that resulted in the user receiving the marketing message and extracting, from the data file, the one or more sharing events that resulted in the user receiving the marketing message and linking the one or more sharing events extracted from the data file with the detected action of the user. The operations further may include accessing data descriptive of a sharing event that indicates a sharing user that directly shared the marketing message with the user and linking, with the detected action of the user, the sharing event that indicates the sharing user that directly shared the marketing message with the user. And, the operations may include accessing data descriptive of a first sharing event that indicates a first sharing user that directly shared the marketing message with the user and a second sharing event that indicates a second sharing user that directly shared the marketing message with the first sharing user and linking, with the detected action of the user, the first sharing event that indicates the first sharing user that directly shared the marketing message with the user and the second sharing event that indicates the second sharing user that directly shared the marketing message with the first sharing user.

In some implementations, the operations may include determining an impact of one or more influencers related to actions taken with respect to the marketing message. In these implementations, the operations may include generating one or more reports that reflect the impact of one or more influencers related to actions taken with respect to the marketing message and outputting the one or more generated reports.

In some examples, the operations may include determining economic characteristics related to sharing events that resulted in actions taken with respect to the marketing message. In these examples, the operations may include generating one or more reports that reflect the economic characteristics related to sharing events that resulted in actions taken with respect to the marketing message and outputting the one or more generated reports.

In some implementations, the operations may include determining an impact of one or more influencers related to actions taken with respect to the marketing message and determining economic characteristics related to sharing events that resulted in actions taken with respect to the marketing message. In these implementations, the operations may include generating one or more reports that reflect the impact of one or more influencers related to actions taken with respect to the marketing message and the economic characteristics related to sharing events that resulted in actions taken with respect to the marketing message and outputting the one or more generated reports.

### BRIEF DESCRIPTION OF THE DRAWINGS

FIGS. 1A to 1C are each diagrams illustrating an example system for providing output based on data descriptive of an influence of an influencer related to a marketing message.

FIG. 2 is a block diagram of an example of a communications system.

FIG. 3 illustrates example data of a social customer relationship management system.

FIG. 4 is a flow chart of an example process for providing output based on data descriptive of an influence of an influencer related to a marketing message.

FIG. 5 is a diagram of an example Graphical User Interface (GUI) for obtaining an agreement from an influencer.

FIG. 6 illustrates an example process for enabling sharing of a marketing message in a manner that enables tracking of actions taken by users to which the marketing message is shared.

FIGS. 7A and 7B are diagrams of example GUIs for enabling an influencer to share a marketing message.

FIG. 8 illustrates an example process for tracking actions related to a marketing message taken by users to which the message was shared by an influencer.

FIG. 9 is a diagram that illustrates an example tracking cookie.

FIG. 10 is a diagram illustrating an example tracking database.

FIG. 11 illustrates an example process for providing output based on data descriptive of an influence of an influencer related to a marketing message.

FIGS. 12 to 22 are diagrams illustrating example outputs based on data descriptive of an influence of an influencer related to a marketing message.

### DETAILED DESCRIPTION

Techniques are described for measuring sharing activity by a social networking user and within a social networking environment through the presentation of a digital offer. The digital offer may be in the form of a coupon, discount ticket, advertisement, box top, card, certificate, credit slip, detachable portion, order blank, premium certificate, ration slip, redeemable part, redemption slip, slip, token, voucher, etc. Additionally, techniques are described for tracking, totalling, and presenting shares in order to identify an influencer and calculate the economic impact in relation to the shares of the influencer.

In some implementations, a system tracks the marketing and economic impact of an influencer. In these implementations, the system performs a measurement of sharing activity by a social networking user (e.g., the influencer) of a digital offer whether it be in the form of a coupon, discount ticket, advertisement, box top, card, certificate, credit slip, detachable portion, order blank, premium certificate, ration slip, redeemable part, redemption slip, slip, token, voucher, etc.

In some examples, companies and organisations may have the ability to measure the economic impact of influencers based on social conversations, engagement, and opt-in across multiple social media and web platforms. In these examples, a system may track the user from initial marketing event or link (e.g., a Facebook Ad, a Blog post, an eMail link, etc.) through to the sharing and exchange of information with friends through to the final opt-in and or eCommerce transaction (e.g., mobile application download, opt-in, or purchase of a ticket, product, or service on an eCommerce site).

Information or “Big Data” may be collected on the server database and managed in a Customer Relationship Management (CRM) system sitting on a server separate from a main tracking application or in a third party CRM system or dataset. Public information may be collected and separately managed from private information collected through a legal opt-in in the CRM system. Data collection in the CRM system includes, for example, the initial marketing event the user clicked on or accessed, profile information, social, behavioural, and demographic information from third party companies, offers selected and redeemed, engagement with friends and followers, and the sales activities and revenues generated from these friend and follower connections.

The data collected from all sources may be visually displayed in a dashboard and framework. The visualisation may highlight key interactions between influencers and friends, influencer economic impact, and the impact of opt-ins of the influencer. Other information displayed is not limited to, but may include what web platform created the greatest engagement or sharing and what marketing channel created the greatest impact in terms of sales and opt-ins.

Influencer data collected from both opt-ins and public data may be managed using a process for measuring economic impact, conversations, followers, and friends by product or service category. The process may deliver a series of scores in the database, including economic brand impact, overall category influence, and overall influence by web or social media platform.

Based on the collection of “Big Data” in the CRM system from various sources, the system may predict, within a certain standard of deviance, influencers who create material impact on brand opt-ins and revenue and sales and opt-in predictions by specific marketing channels.

With the collection of “Big Data” and trends derived from the information, the system may deliver information back to the opt-in or potential customer or existing customer and deliver campaigns and pages that are highly personalized with information to enable customers to receive highly directed information with potentially higher rates of conversion.

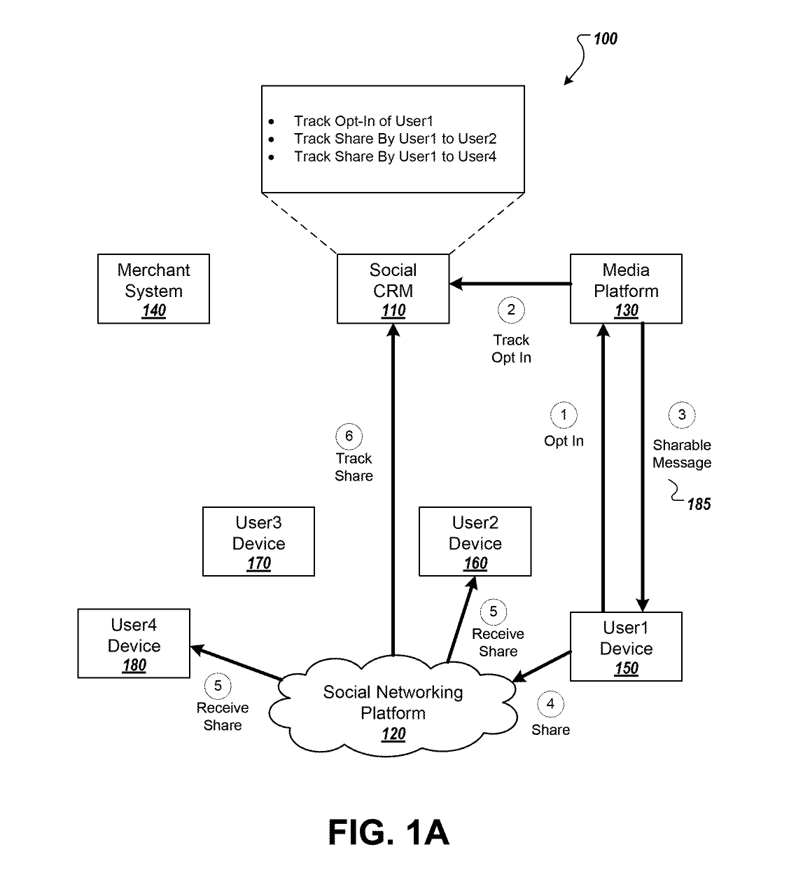

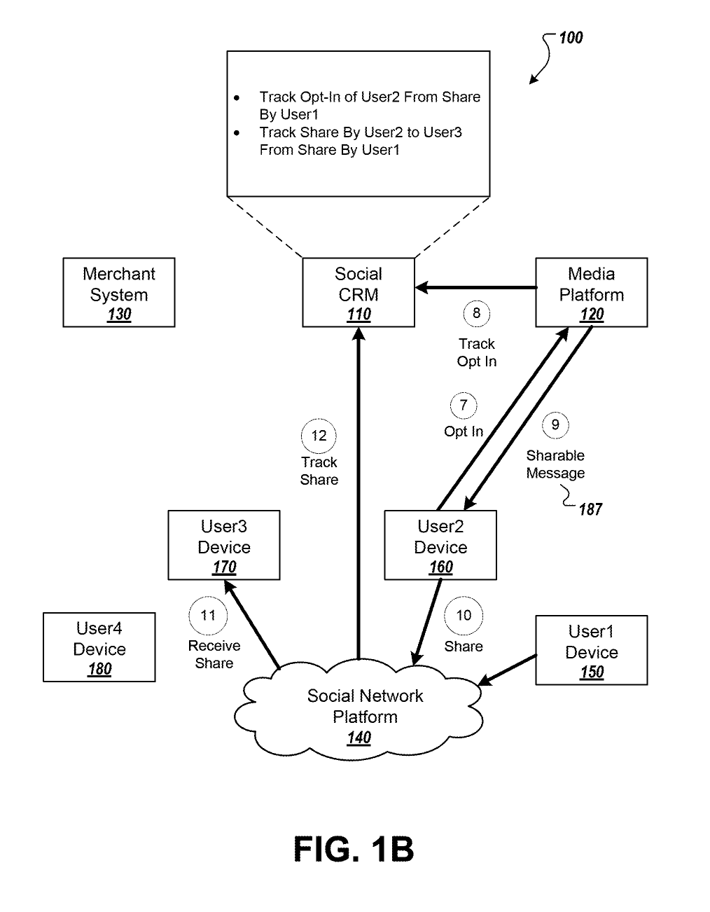

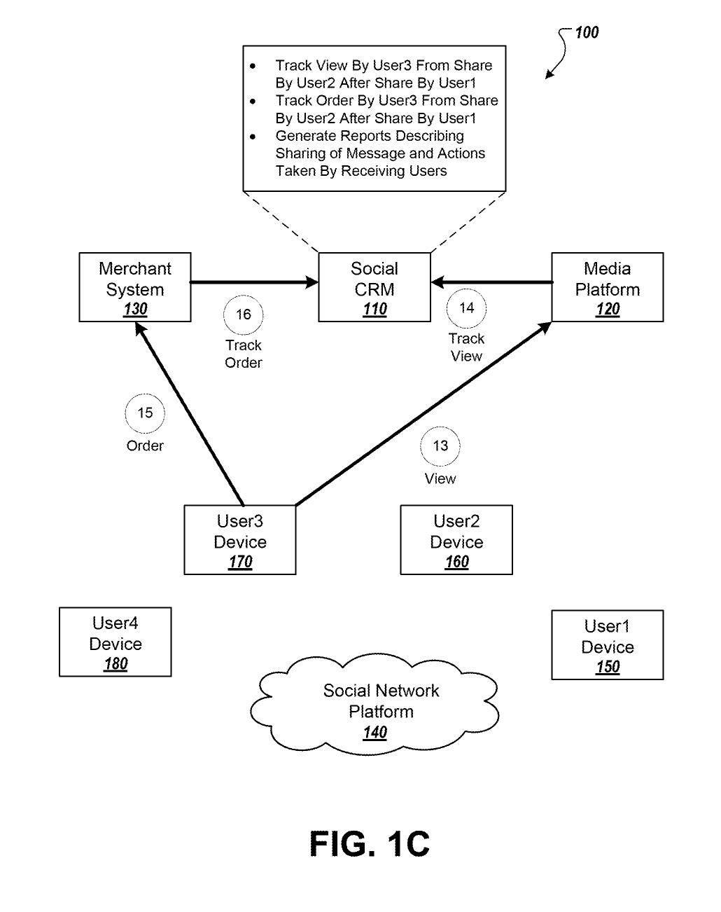

FIG. 1A illustrates an example system 100 for providing output based on data descriptive of an influence of an influencer related to a marketing message. A social CRM (Customer Relationship Management) system 110 can be used to provide companies and organizations the ability to measure the economic impact of influencers based on social conversations, engagements, and opt-ins across multiple social media and other platforms, including a social networking platform 120. In some implementations, the social networking platform 120 may be a social networking platform, such as Facebook, Twitter, LinkedIn, Google+, MySpace, and Orkut, among others.

The social CRM system 110 can track activities associated with a user from an initial marketing event or link (e.g., social media post, blog post, email message, etc.), such as provided by a media platform 130, to a sharing and exchange of information with friends, to an opt-in, and to an online transaction (e.g., mobile application download, or purchase of a ticket, product or service on an eCommerce site), such as from a merchant system 140. The social CRM system 110 can analyze tracked data and can calculate a number of impact measures, such as an economic impact of a social media channel, an economic impact of an influencer, or the economic impact of an influencer on a particular brand.

A set of example tracking activities performed by the social CRM system 110 is described below using a set of example steps. In a first step, a user one opts in to an agreement to allow tracking of sharing of marketing messages provided by the media platform 130 and to abide by corporate and governmental privacy statements. User one may, for example, visit a site associated with the media platform 130 or the merchant system 140 and may select a user interface option to opt in to the agreement. As another example, user one may perform an opt-in as a response to a distribution of a marketing message related to a good or service sent from the media platform 130 to a user one device 150 associated with user one.

The opt-in can provide rights to the social CRM system 110 and/or to the media platform 130 to access, for example, a user name, email address, phone number, home address or other personal profile elements of a user. User one may agree to provide such information to continue engagement with an organization and to derive associated benefits of an offered service or product. An opt-in can provide an organization an opportunity to market directly to potential and existing customers.

An indication of the opt-in can be sent from the user one device 150 to the media platform 130. In step two, the media platform 130 provides an indication of the opt-in by user one to the social CRM system 110. The social CRM system 110 can track the opt-in, such as by storing data associated with the opt-in in a data store, in association with user one.

The opt-in can represent an agreement by user one to allow tracking of user one's sharing of marketing messages received, for example, from the media platform 130. For example, in step three, the media platform 130 provides a sharable message 185 to the user one device 150. The sharable message 185 can be, for example, a message shared through the social networking platform 120, a text message, an instant message, or an electronic mail message.

The social CRM system 110 can enable sharing of the sharable message 185 in a manner that enables tracking of actions taken by users to which the sharable message 185 is shared. For example, the social CRM system 110 can determine a message identifier for the sharable message 185, can determine an influencer identifier for user one, and can generate a sharing identifier based on the message identifier and the influencer identifier. The sharing identifier can be embedded in sharable message 185 and later extracted from the sharable message 185 by the social CRM system 110 to track actions related to the sharable message 185.

In step four, user one shares the sharable message 185 to a user two and a user four, using the social networking platform 120. For example, user one may select a share control that is included in the sharable message 185. As another example, user one may share the sharable message 185 with user two and user four by forwarding the sharable message 185. An indication of the sharing of the sharable message 185 may be sent to the social networking platform 120 from the user one device 150.

In step five, user two and user four receive the sharable message 185. For example, the social networking platform 120 can send the sharable message 185 to a user two device 160 and a user four device 180. The sharable message 185 received from the user one device 150 can include the previously generated sharing identifier.

In step six, an indication of the sharing of the sharable message 185 is sent to the social CRM system 110 (e.g., from the social networking platform 120). The social CRM system 110 can track the sharing of the sharable message 185, such as by storing the sharing identifier, in association with user two and user four, in a data store.

Further example tracking performed by the social CRM system 110 is illustrated in FIG. 1B. In step seven, user two opts in to an agreement to allow tracking of sharing of marketing messages provided by the media platform 130 and to abide by corporate and governmental privacy statements. To opt in, user two may, for example, select a user interface control included in the sharable message 185 received from user one. An indication of the opt-in can be sent from the user two device 160 to the media platform 130.

In step eight, the media platform 130 provides an indication of the opt-in by user two to the social CRM system 110. The social CRM system 110 can track the opt-in, such as by storing data associated with the opt-in in a data store, in association with user two.

In step nine, the media platform 130 provides a sharable message 187 to the user two device 160. The sharable message 187 can be, for example, a message shared through the social networking platform 120, a text message, an instant message, or an electronic mail message.

In step ten, user two shares the sharable message 187 to a user three, using the social networking platform 120. For example, user two may select a share control that is included in the sharable message 187. As another example, user two may share the sharable message 187 with user three by forwarding the sharable message 187. An indication of the sharing of the sharable message 187 may be sent to the social networking platform 120 from the user two device 150.

In step eleven, user three receives the sharable message 187. For example, the social networking platform 120 can send the sharable message 187 to a user three device 170.

In step twelve, an indication of the sharing of the sharable message 187 is sent to the social CRM system 110 (e.g., from the social networking platform 120). The social CRM system 110 can track the sharing of the sharable message 187, such as by storing an identifier of the sharable message 187, in association with user one, user two, and user three.

Further example tracking performed by the social CRM system 110 is illustrated in FIG. 1C. In step thirteen, user three views the sharable message 187 received from user two, but does not perform an opt-in operation. An indication of the viewing of the sharable message 187 can be sent from the user three device 170 to the media platform 130.

In step fourteen, an indication of the viewing of the sharable message 187 by user three is sent to the social CRM system 110 from the media platform 130. The social CRM system 110 can track the viewing of the sharable message 187, such as by storing an identifier of the sharable message 187 and an indication of the view action, in association with user three.

In step fifteen, user three orders a product from the merchant system 140. A sharing identifier associated with the sharing of the sharable message 187 from user two to user three may be communicated to or retrieved by the merchant system 140.

In step sixteen, the order is tracked. For example, order information and the sharing identifier can be communicated to or retrieved by the social CRM system 110 from the merchant system 140. The order information and the sharing identifier can be used to track that user three made a purchase after receiving the sharable message 187 from user two, where the sharable message 187 is a copy of the sharable message 185 received by user two from user one.

The social CRM system 110 can determine, based on tracked data, data descriptive of an influence of an influencer related to a marketing message such as the sharable message 185. The social CRM system 110 can provide output based on the determined data. For example, the social CRM system 110 can generate and output one or more reports that reflect the impact of one or more influencers related to actions taken with respect to a marketing message and/or economic characteristics related to sharing events that resulted in actions taken with respect to the marketing message. Example outputs and reports are described in more detail below.

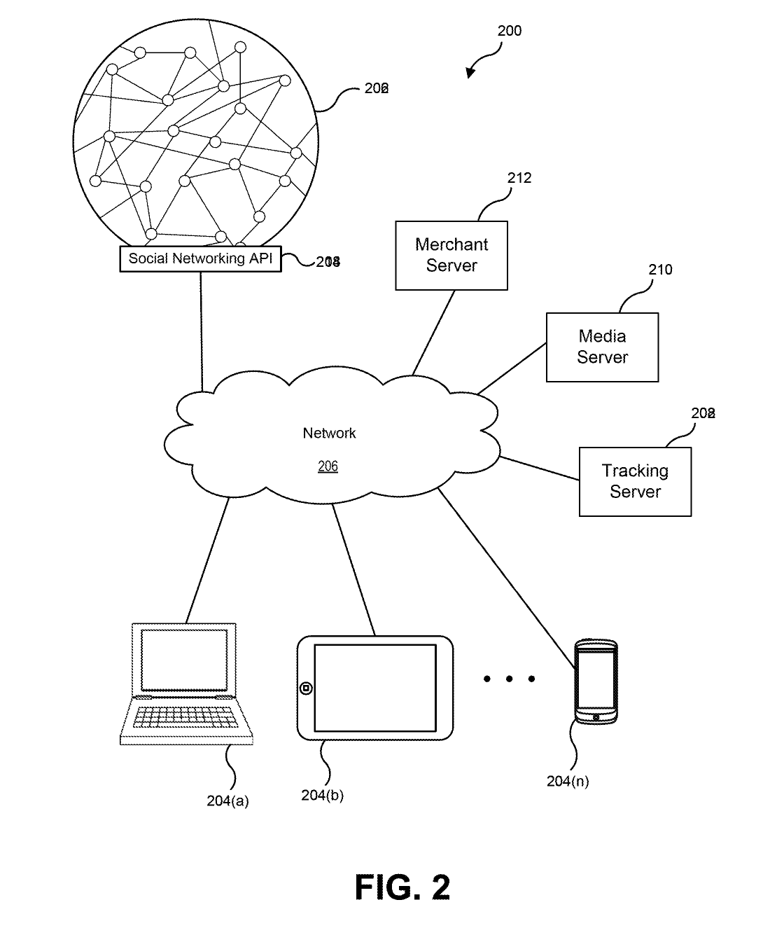

FIG. 2 illustrates an example of a communications system 200. For illustrative purposes, several elements illustrated in FIG. 2 and described below are represented as monolithic entities. However, these elements each may include and/or be implemented on numerous interconnected computing devices and other components that are designed to perform a set of specified operations.

As illustrated in FIG. 2, the communications system 200 includes an electronic social networking platform 202 that is accessible to a number of computing devices or other electronic devices 204(a)-204(n), including, for example, a laptop computer 204(a), a tablet computer 204(b), and a smartphone 204(n), over a network 206. In addition, the communications system 200 also includes a tracking server 208, a media server 210, and a merchant server 212. Each of the tracking server 208, the media server 210, and the merchant server 212 may be external to the electronic social networking platform 202. As such, the electronic social networking platform 202 may be accessible to each of the tracking server 208, the media server 210, and the merchant server 212 over the network 206. Additionally, each of the tracking server 208, the media server 210, and the merchant server 212 may be accessible to the electronic devices 204(a)-204(n) over the network 206.

The electronic social networking platform 202 may be implemented using one or more computing devices (e.g., servers) configured to provide a service to one or more client devices (e.g., electronic devices 204(a)-204(n)) connected to electronic social networking platform 202 over network 206. The one or more computing devices on which electronic social networking platform 202 is implemented may have internal or external storage components storing data and programs such as an operating system and one or more application programs. The one or more application programs may be implemented as instructions that are stored in the storage components and that, when executed, cause the one or more computing devices to provide the features of an electronic social networking platform 202. Furthermore, the one or more computing devices on which the electronic social networking platform 202 is implemented each may include one or more processors for executing instructions stored in storage and/or received from one or more other electronic devices, for example over the network 206. In addition, these computing devices also typically may include network interfaces and communication devices for sending and receiving data. The electronic social networking platform 202 also may provide an application programming interface (API) 214 that enables other applications to interact with and extract data from the electronic social networking platform 202.

The electronic social networking platform 202 can be represented as a graph of nodes connected by edges. In some implementations, each node represents an individual user identity of the electronic social networking platform 202. In such implementations, an edge that connects two nodes represents a connection that has been formed between the two user identities that are represented by the connected nodes.

There are many different examples of electronic social networking platforms. As described above, Facebook, Twitter, LinkedIn, Google+, MySpace, and Orkut are a few examples. But, there are many others, and it is reasonable to expect many more to be launched in the future.

The electronic social networking platform 202 can enable individual user identities (e.g., users who have registered with the platform and/or who have been assigned a unique or otherwise identifying identifier by the platform) to establish connections with other user identities. These connections between user identities may reflect relationships between the underlying human users who correspond to the user identities. For example, a connection between two user identities within the electronic social networking platform 202 may reflect a social friendship (e.g., developed through physical interaction in the real-world and/or through on-line interaction in the cyber-world) or a professional relationship between the underlying human users who correspond to the user identities.

A user identity of the electronic social networking platform 202 may form connections to other user identities of the electronic social networking platform 202, thus forming a personal social network defined within the overall social networking platform 202. As used herein, the social network of a particular entity refers to the connections and entities for the particular entity, which form a subset of the entities and connections in the broader social networking platform 202, which encompasses the user identities for all entities and the connections among them. In some cases, the social network of a particular user identity of the electronic social networking platform 202 may be defined as the group of other user identities to whom the particular user identity is directly connected. Alternatively, in other cases, the social network of a particular user identity of the electronic social networking platform 202 may be defined to include a group of other user identities that are within a threshold number of degrees of separation of the particular user identity within the graph.

The social networking platform 202 may enable user identities to record endorsements of various different types of interests, for example, by establishing connections to interest objects that represent these interests. Such interest objects may include a variety of different types of objects including, for example, non-personal enterprise objects. Examples of such non-personal enterprise objects may include, among others, local businesses or places (e.g., restaurants, retail stores, parks, train or bus stations, airports, etc.); companies, organizations, or institutions; brands or products; artists, bands, or public figures; forms of entertainment (e.g., books, music albums, movies, etc.); and causes or communities. In the electronic social networking platform 202, interest objects, including non-personal enterprise objects, may be manifested within the electronic social networking platform 202 as so-called “pages.” These pages, especially pages associated with non-personal enterprise interest objects, may be maintained by one or more representatives of the interests or non-personal enterprises represented by the objects. In addition, among other features, these pages may provide information about the interests or non-personal enterprises represented by the objects. These pages also may provide conduits for enabling interaction between the interest or non-personal enterprise objects and the user identities that have formed connections to the objects that represent them. The social networking platform 202 may enable user identities to establish connections with independent applications that leverage the social networking platform 202, for example, by granting the independent applications authorization to access or extract data from the electronic social networking platform 202 on their behalf.

The electronic devices 204(a)-204(n) may be any of a number of different types of computing devices including, for example, mobile phones; smartphones; personal digital assistants; laptop, tablet, and netbook computers; and desktop computers including personal computers, special purpose computers, general purpose computers, and/or combinations of special purpose and general purpose computers. Each of the electronic devices 204(a)-204(n) typically may have internal or external storage components for storing data and programs such as an operating system and one or more application programs. In particular, the internal or external storage components for each of the electronic devices 204(a)-204(n) may store a client application for interfacing with the electronic social networking platform 202 and/or one or more client applications for interfacing with one or more of the tracking server 208, the media server 210, and the merchant server 212. Additionally or alternatively, the electronic devices 204(a)-204(n) may be configured to interface with the electronic social networking platform 202, the tracking server 208, the media server 210, or the merchant server 212 without a specific client application, using, for example, a web browser.

Each of the electronic devices 204(a)-204(n) also typically may include a central processing unit (CPU) for executing instructions stored in storage and/or received from one or more other electronic devices, for example over the network 206. Each of the electronic devices 204(a)-204(n) also usually may include one or more communication devices for sending and receiving data. One example of such communications devices is a modem. Other examples include antennas, transceivers, communications cards, and other network adapters capable of transmitting and receiving data over a network (e.g., the network 206) through a wired or wireless data pathway.

The network 206 may provide direct or indirect communication links between the electronic social networking platform 202, the electronic devices 204(a)-204(n), the tracking server 208, the media server 210, and the merchant server 212. Examples of the network 206 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data.

Each of the tracking server 208, the media server 210, and the merchant server 212 may be implemented using one or more computing devices (e.g., servers). The one or more computing devices on which each of the tracking server 208, the media server 210, and the merchant server 212 is implemented may have internal or external storage components storing data and programs such as an operating system and one or more application programs. Each of the one or more application programs may be implemented as instructions that are stored in the storage components and that, when executed, cause one or more computing devices to provide the features ascribed herein to the respective tracking server 208, media server 210, or merchant server 212. Furthermore, the one or more computing devices on which the tracking server 208, the media server 210, or the merchant server 212 is implemented each may include one or more processors for executing instructions stored in storage and/or received from one or more other electronic devices, for example, over the network 206. In addition, these computing devices also typically may include network interfaces and communication devices for sending and receiving data.

Each of the tracking server 208, the media server 210, and the merchant server 212 may host an application that leverages electronic social networking platform 202. As such, each of the tracking server 208, the media server 210, and the merchant server 212 may be configured to extract and process data from electronic social networking platform 202. For example, the tracking server 208 may be configured to exploit the API 214 to extract data from the electronic social networking platform 202. Among other features, each of the tracking server 208, the media server 210, and the merchant server 212 may be configured to extract data about multiple different user identities' social networks including one or more of (i) information identifying the members of each user identity's social network; (ii) communications shared with each user identity as well as communications shared with each member of the user identity's social network; (iii) information about locations where each user identity has checked-in as well as information about locations where each member of the user identity's social network has checked-in; and (iv) contact information (e.g., addresses) for each member of the user identity's social network.

In FIG. 2, the tracking server 208 may be a server system for the social CRM system 110 discussed above with respect to FIG. 1, the media server 210 may be a server for the media platform 130 discussed above with respect to FIG. 1, and the merchant server 212 may be a server for the merchant system 140 discussed above with respect to FIG. 1. Each of the electronic devices 204(a)-204(n) may be used as each of the user one device 150, the user two device 160, the user three device 170, and the user four device 180 discussed above with respect to FIG. 1. Further, the social networking platform 202 and API 214 may be part of the social networking platform 120 and perform operations discussed above with respect to FIG. 1.

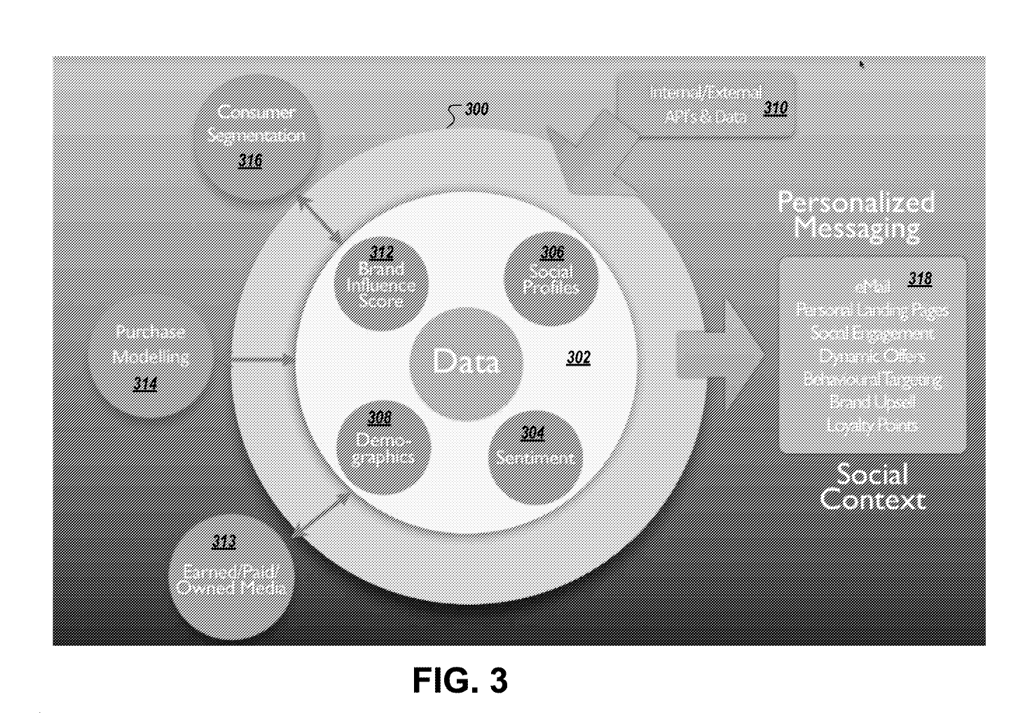

FIG. 3 illustrates example data 302 of a social CRM system 300. The data 302 can include sentiment data 304, social profile data 306, and demographic data 308. The sentiment data 304 can include, for example, public postings made by users using one or more social networking platforms. The social profile data 306 and the demographics data 308 can include personal information about users of one or more social networking platforms. Some or all of the social profile data 306, the sentiment data 304, and the demographics data 308 can be obtained using one or more internal or external (e.g., third party) API's 310.

The data 302 can include brand influence score data 312, which can be determined by the social CRM system 300 by tracking sharing of marketing messages by influencers in a social networking platform, tracking actions related to marketing messages taken by users to which the marketing messages have been shared by an influencer, and determining data that is descriptive of an influence of the influencer related to the marketing messages. In some implementations, a brand influence score can be based on weighted components, where the weighted components include a total brand economic impact, a determined brand engagement, and a number of followers in a social networking platform. Engagement can be based, for example, on a percentage of followers of an influencer who respond to a message related to a brand that is shared by the influencer.

The social CRM system 300 can obtain data related to actions of consumers in response to campaigns or strategies associated with earned, paid, and owned media 313. Paid media refers to media used for traditional advertising for which an organization pays, such as television, print, radio, or web page banner ads. Owned media refers to media that an organization owns or controls, such as an organization's own web page. Earned media can refer to conversations and communications made by consumers of an organization in a social networking platform, including the sharing of messages between consumers.

The social CRM system 300 can obtain data related to one or more purchase modeling processes 314, where the purchase modeling processes 314 may be internal or external to the social CRM system 300. The purchase modeling processes 314 can determine, for example, the likelihood of a consumer to purchase a particular product or service in a particular timeframe, based, for example, on some or all of the data 302.

The social CRM system 300 can obtain data related to one or more customer segmentation processes 316, where the customer segmentation processes may be internal or external to the social CRM system 300. The customer segmentation processes 316 can segment consumers, for example, based on one or more of the sentiment data 304, the social profile data 306, the demographic data 308, the brand influence score data 312, or data obtained from the purchase modeling processes 314.

The social CRM system 300 can perform personalized messaging services 318, based on the data 302. For example, the social CRM system 300 can identify consumers who have a brand influence score greater than a threshold, can send a message to such consumers, and can track responses to the message, updating the data 302 based on the responses. As another example, the social CRM system can identify consumers having a likelihood to purchase a product that is higher than a threshold, and can send a message to such consumers.

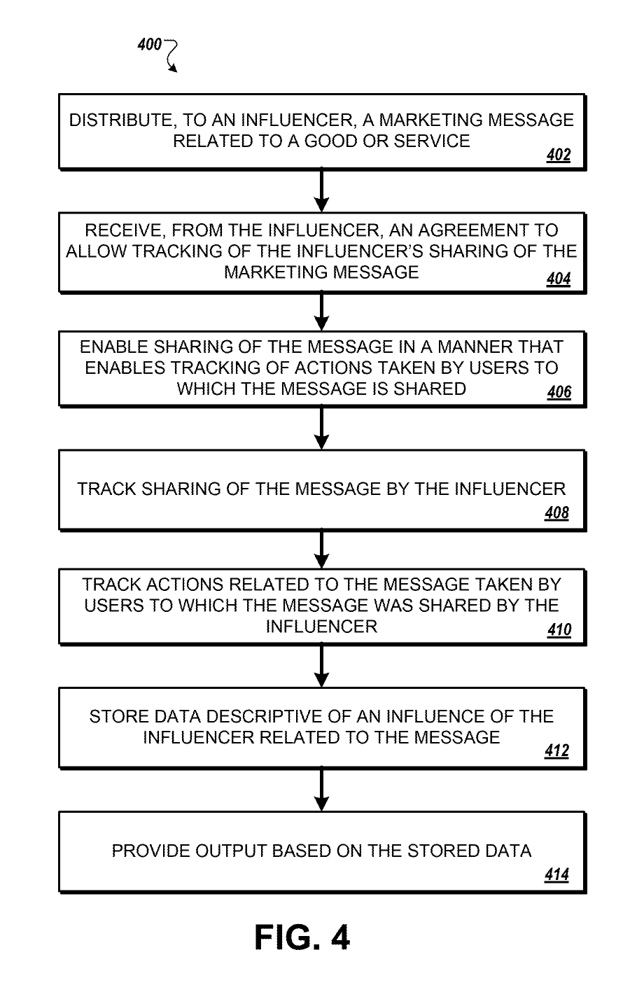

FIG. 4 illustrates an example process 400 for providing output based on data descriptive of an influence of an influencer related to a marketing message. The process 400 may be performed by a computing system, such as, for example, the social CRM system 110, the social networking platform 120, the social networking platform 202, or the tracking server 208. Briefly, the process 400 includes distributing, to an influencer, a marketing message related to a good or service (402); receiving, from the influencer, an agreement to allow tracking of the influencer's sharing of the marketing message (404); enabling sharing of the message in a manner that enables tracking of actions taken by users to which the message is shared (406); tracking sharing of the message by the influencer (408); tracking actions related to the message taken by users to which the message was shared by the influencer (410); storing data descriptive of an influence of the influencer related to the message (412); and providing output based on the stored data (414). For convenience, operations of the process 400 are described as being performed by the social CRM system 110. However, as mentioned above, the operations of the process 400 may be performed by other computer systems described throughout this disclosure or an electronic device that includes a processor.

The social CRM system 110 distributes, to an influencer, a marketing message related to a good or service (402). The marketing message can distributed, for example, through a social networking platform, as a text message, as an instant message, or as an electronic mail message. The marketing message may relate to a particular brand associated with an organization.

The social CRM system 110 receives, from the influencer, an agreement to allow tracking of the influencer's sharing of the marketing message (404). The agreement can be used, for example, to validate the influencer and to ensure that the influencer opts in and agrees to a set of corporate and/or governmental privacy statements.

In some implementations, to receive an agreement from the influencer, an inducement is presented to the influencer to encourage the influencer to opt in and agree to the set of corporate and governmental privacy statements. For example, receipt of or participation in a free product, a leaderboard score, a prize, a contest, a sweepstakes, a trivia poll, or some other inducement can be offered in exchange for the influencer opting in and agreeing to the set of corporate and governmental privacy statements.

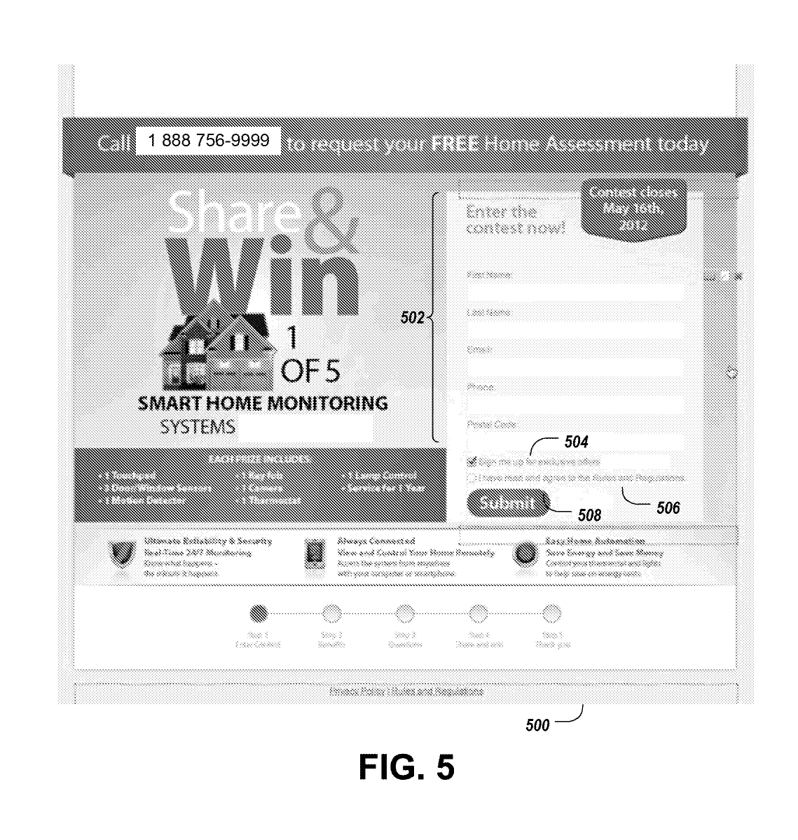

For example, FIG. 5 is a diagram of an example GUI 500 for obtaining an agreement from an influencer. The influencer can provide information to enter a contest sponsored by an organization. The influencer can provide personal information, such as a first name, last name, email address, phone number, and postal code, using a set of controls 502. The influencer can select a control 504 to opt-in to receiving offers from the organization. The user interface 500 can be configured to ensure that the influencer selects a control 506 to signify agreement to rules and regulations before submitting information using the user interface 500. Information can be submitted by selecting a control 508. Other types of opt-in user interfaces are possible, including user interfaces that are generated either entirely or in part through integration with one or more APIs of a social networking platform.

Referring again to FIG. 4, the social CRM system 110 enables, after receiving the agreement to allow tracking of the influencer's sharing of the marketing message, sharing of the marketing message in a manner that enables tracking of actions taken by users to which the marketing message is shared (406). For example, the social CRM system 110 can enabling sharing of the marketing message through at least one of a social network, a text message, an instant message, and an electronic mail message.

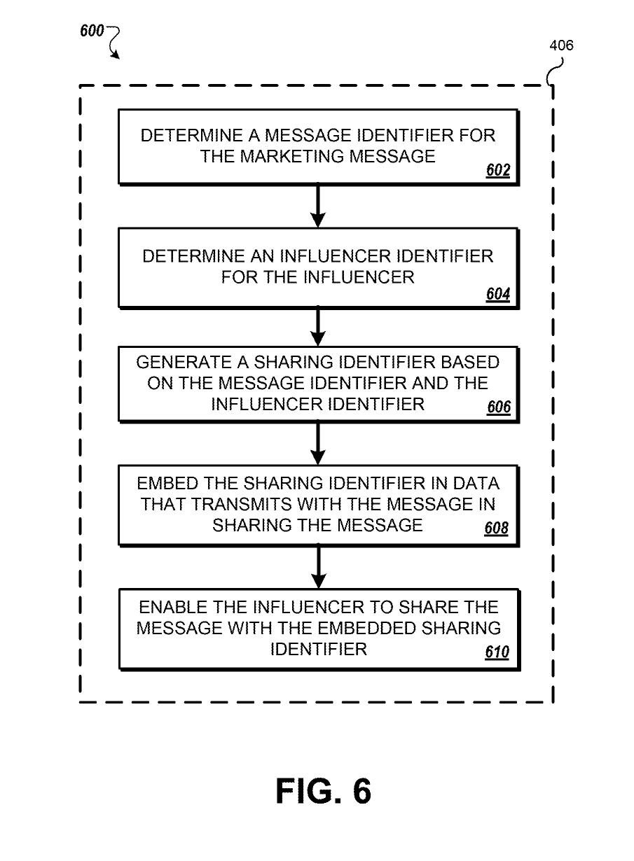

As another example, FIG. 6 illustrates an example process 600 for enabling sharing of a marketing message in a manner that enables tracking of actions taken by users to which the marketing message is shared. The process 600 may be used in enabling sharing of the marketing message in a manner that enables tracking of actions taken by users to which the marketing message is shared described above with reference to numeral 406 in FIG. 4. For convenience, operations of the process 600 are described as being performed by the social CRM system 110. However, the operations of the process 600 may be performed by other computer systems described throughout this disclosure or an electronic device that includes a processor.

The social CRM system 110 determines a message identifier for the marketing message (602). The message identifier can be associated, for example, with an organization, a brand of the organization, and the marketing message.

The social CRM system 110 determines an influencer identifier for the influencer (604). The influencer identifier can be, for example, based on a cookie associated with the influencer. As another example, the influencer identifier can be a unique URL that is associated with the influencer.

The social CRM system 110 generates a sharing identifier based on the message identifier and the influencer identifier (606). For example, the social CRM system 110 can dynamically generate a unique URL that includes the message identifier and the influencer identifier.

The social CRM system 110 embeds the sharing identifier in data that transmits with the marketing message in sharing the marketing message (608). For example, the social CRM system 110 can place the dynamically-generated unique URL in the marketing message, for example, as or included in a user-selectable link that is included in the marketing message.

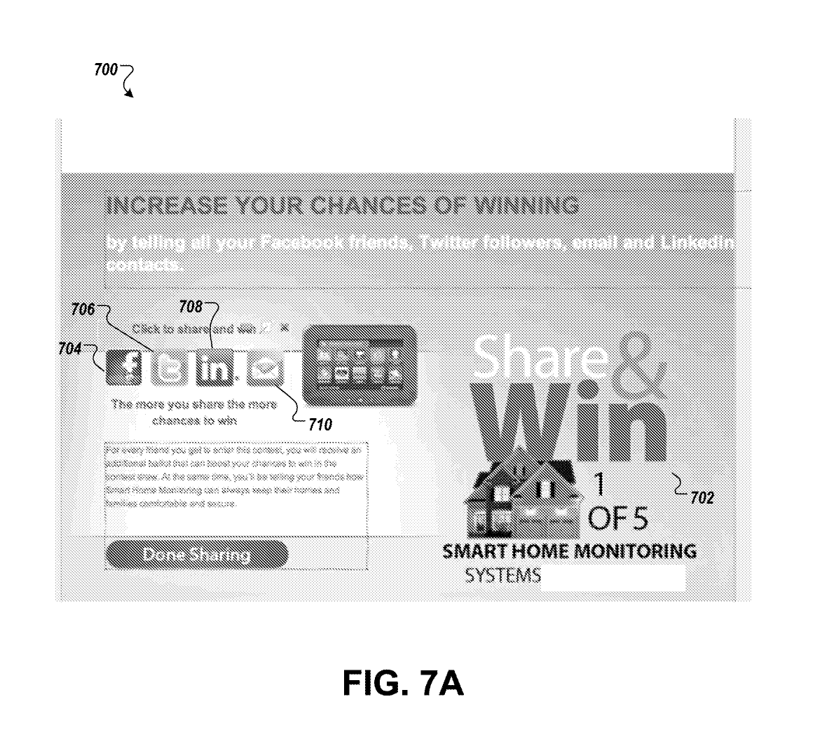

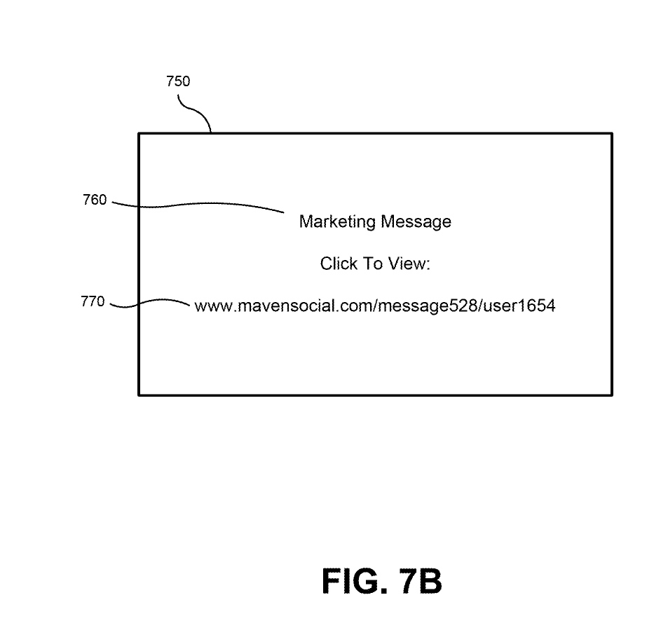

The social CRM system 110 enables the influencer to share the marketing message with the embedded sharing identifier (610). For example, FIG. 7A is a diagram of an example GUI 700 for enabling an influencer to share a marketing message 702. The marketing message 702 is related to a promotion through which an influencer may win a home monitoring system. The influencer can increase their chances of winning by sharing the marketing message 702 with people to which the influencer is connected. For example, the influencer can select controls 704, 706, 708, and 710, to share the marketing message with Facebook friends, Twitter followers, LinkedIn contacts, and email contacts, respectively. In response to selection of one of the controls 704, 706, 708, or 710, a marketing message that includes the marketing message 702 and an embedded sharing identifier can be shared with one or more people or entities associated with the influencer.

As another example, FIG. 7B is a diagram of an example GUI 750 for enabling an influencer to share a marketing message 760. The GUI 750 includes a URL 770, which is a sharing identifier that includes a message identifier (e.g., “message528”) and an influencer identifier (e.g., “user1654”).

Referring again to FIG. 4, the social CRM system 110 tracks sharing of the marketing message by the influencer (408). For example, the social CRM system 110 can receive, over a network, an indication of sharing of the marketing message by the influencer and can track the sharing of the marketing message by the influencer based on receiving the indication. As a more particular example, the social CRM system 110 can receive an indication from a social networking platform that the influencer shared the marketing message within the social networking platform, and can receive an indication of one or more users of the social networking platform to which the influencer shared the marketing message. For instance, in the example of FIG. 1A, the social CRM system 110 can receive indications that the sharable message 185 was shared, by user one, to users two and four. The social CRM system 110 can track such received indications.

The social CRM system 110 tracks actions related to the marketing message taken by users to which the message was shared by the influencer (410). For example, the social CRM system 110 may track views of the marketing message, opt-ins related to the marketing message, and orders related to the marketing message.

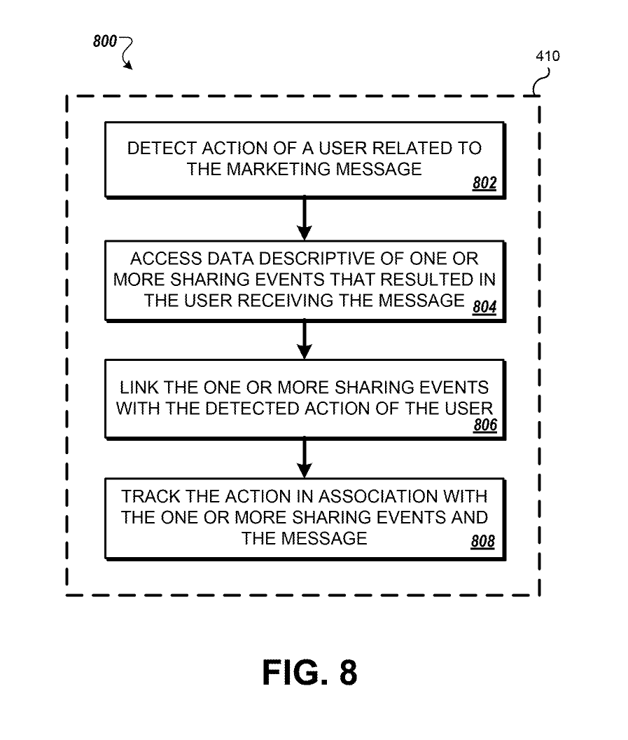

FIG. 8 illustrates an example process 800 for tracking actions related to the marketing message taken by users to which the message was shared by the influencer. The process 800 may be used in tracking actions related to the marketing message taken by users to which the message was shared by the influencer described above with reference to numeral 410 in FIG. 4. For convenience, operations of the process 800 are described as being performed by the social CRM system 110. However, the operations of the process 800 may be performed by other computer systems described throughout this disclosure or an electronic device that includes a processor.

The social CRM system 110 detects an action of a user related to the marketing message (802). The social CRM system 110 can detect that the user viewed the marketing message, performed an opt-in related to the marketing message, made a purchase related to the marketing message, deleted the marketing message, or further shared the marketing message, to name a few examples. For a purchase, the social CRM system 110 can receive, over a network and from a merchant server of a merchant, an indication that the user made, from the merchant, a purchase related to the marketing message.

The social CRM system 110 accesses data descriptive of one or more sharing events that resulted in the user receiving the marketing message (804). For example, the social CRM system 110 can access data descriptive of one or more sharing events from a data store included in the social CRM system 110. The data store can include, for example, multiple records of sharing events, including records which indicate, such as through one or more relationships among multiple records, data that is descriptive of a first sharing event that indicates a first sharing user that directly shared the marketing message with the user and a second sharing event that indicates a second sharing user that directly shared the marketing message with the first sharing user.

As another example, the social CRM system 110 can access, from electronic storage on a device of the user, a data file that records one or more sharing events that resulted in the user receiving the marketing message. The data file can be or can include, for example, a cookie.

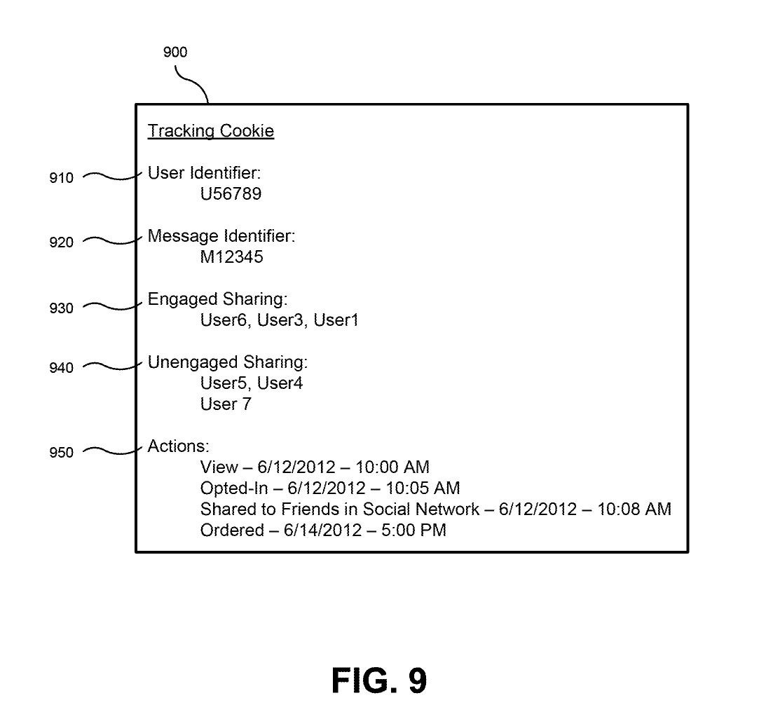

FIG. 9 is a diagram that illustrates an example tracking cookie 900. The tracking cookie 900 includes a user identifier 910 (e.g., “U56789”) and a message identifier 920 (e.g., “M12345”). Although one message identifier is illustrated, the tracking cookie 900 can include multiple message identifiers and data corresponding to each message identifier.

For the message identifier 920, the tracking cookie 900 includes information 930 related to engaged sharing and information 940 related to unengaged sharing. The engaged sharing information 930 includes information relating to receipt by the user of a shared marketing message associated with the message identifier 920 in response to which the user subsequently took some action (e.g., view, opt-in, purchase, further share, etc.). For example, the engaged sharing information 930 indicates that a “User6” user shared the marketing message with the user, and that a “User3” user had shared the marketing message with the “User6” user, and that a “User1” user had shared the marketing message with the “User3” user.

In general, the social CRM system 110 can access data in the tracking cookie 900 that is descriptive of a sharing event that indicates a sharing user that directly shared the marketing message with the user (e.g., “User6”). The social CRM system 110 can also access data in the tracking cookie 900 that is descriptive of a first sharing event that indicates a first sharing user that directly shared the marketing message with the user (e.g., “User6”) and a second sharing event that indicates a second sharing user (e.g., “User3”) that directly shared the marketing message with the first sharing user.

Action information 950 can include information on actions taken by the user in response to the message shared to the user by “User6.” For example, the action information indicates that the user, on June 12, viewed the message, opted in to an associated agreement, and shared the message to one or more friends in a social network, and subsequently made a purchase related to the message on June 14.

The unengaged sharing information 940 includes information relating to receipt by the user of a marketing message associated with the message identifier 920, where the user did not take any action in response to the marketing message. For example, the unengaged sharing information 940 indicates that a “User5” user and a “User7” user shared the marketing message with the user and that the user did not respond to such messages. For example, the user may not have viewed such messages.

Referring again to FIG. 8, the social CRM system 110 links the one or more sharing events with the detected action of the user (806). If the one or more sharing events that resulted in the user receiving the marketing message are accessed from a data file from a device of the user, the social CRM system 110 can extract the one or more sharing events and can link the one or more extracted sharing events with the detected action of the user. The social CRM system 110 can, for example, link the detected action of the user with a sharing event that indicates a sharing user that directly shared the marketing message with the user. As another example, the social CRM system 110 can link the detected action of the user with a first sharing event that indicates a first sharing user that directly shared the marketing message with the user and a second sharing event that indicates a second sharing user that directly shared the marketing message with the first sharing user (as well as third, fourth, etc. sharing users who made other, previous shares of the marketing message).

The social CRM system 110 tracks the detected action of the user in association with the one or more sharing events and the marketing message (808). For example, the social CRM system 110 can track one or more of a view of the marketing message, an opt-in related to the marketing message, and a purchase related to the marketing message in association with the one or more sharing events and the marketing message. Actions can be tracked in a tracking cookie and/or in a tracking database.

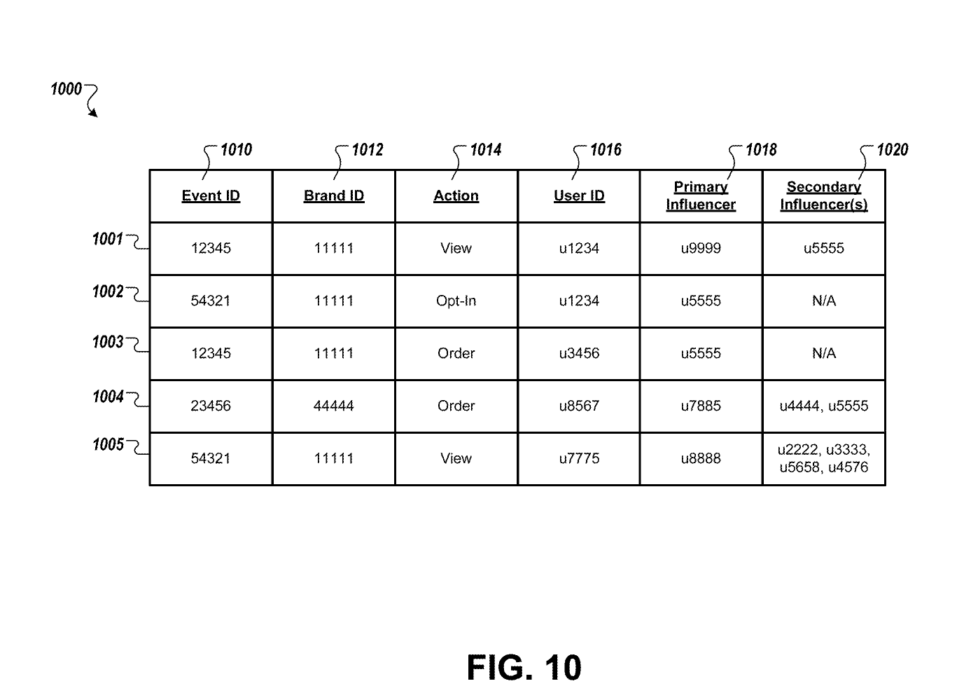

For example, FIG. 10 is a diagram illustrating an example tracking database 1000. The tracking database 1000 includes example records 1001, 1002, 1003, 1004, and 1005. For each of the records 1001, 1002, 1003, 1004, and 1005, an event identifier 1010, a brand identifier 1012, an action indicator 1014, a user identifier 1016, a primary influencer identifier 1018, and zero or more secondary influencers 1020 can be stored. For example, information in the record 1001 indicates that a user with identifier “u1234” received a shared message with an event (e.g., a marketing message) identifier of “12345” from the user with identifier “u9999”, where the marketing message is associated with a brand with identifier “11111.” The record 1001 also indicates that the user “u1234” viewed the marketing message and that a user with identifier “u5555” shared the marketing message with the user “u9999” before the user “u9999” shared the marketing message with the user “u1234”.

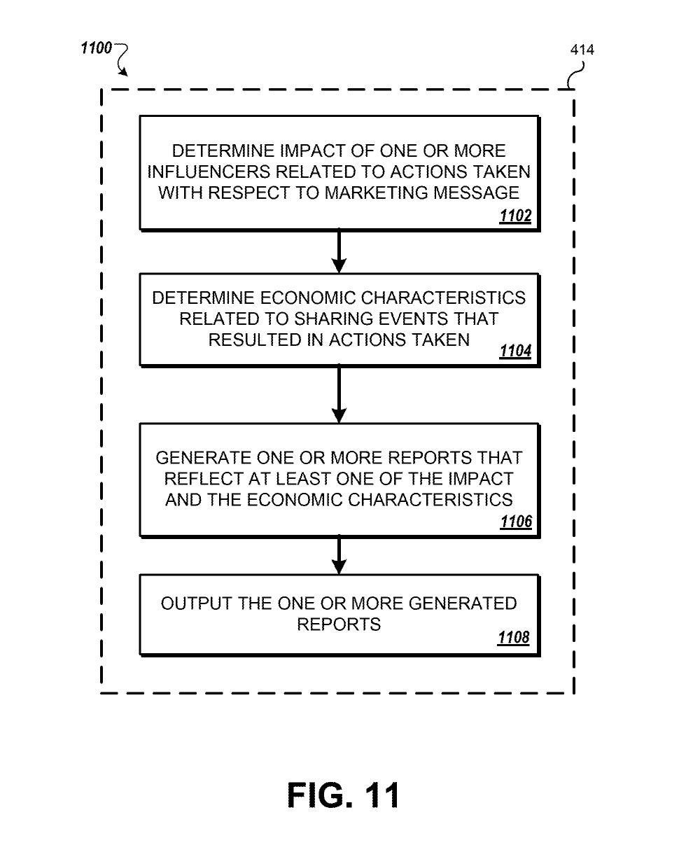

Referring again to FIG. 4, the social CRM system 110 stores data descriptive of an influence of the influencer related to the marketing message (412). The social CRM system 110 can provide output based on the stored data (414). For example, FIG. 11 illustrates an example process 1100 for providing output based on data descriptive of an influence of an influencer related to a marketing message. The process 1100 may be used in storing data descriptive of an influence of an influencer related to a marketing message and providing output based on the stored data described above with reference to numerals 412 and 414 in FIG. 4. For convenience, operations of the process 1100 are described as being performed by the social CRM system 110. However, the operations of the process 1100 may be performed by other computer systems described throughout this disclosure or an electronic device that includes a processor.

The social CRM system 110 determines an impact of one or more influencers related to actions taken with respect to the marketing message (1102). For example, in some implementations, the social CRM 110 can determine, for each influencer, information related to actions taken by other influencers after receiving a message shared from the influencer, including a number of opt-ins, a total value of products ordered, a number of views of the marketing message, and a number of further sharings of the marketing message. One or more scores (e.g., a brand influence score) can be determined for each influencer, and influencers can be ranked by the one or more scores. In some implementations, a score can be based on a determined brand engagement (e.g., as determined by actions following sharing by an influencer of messages associated with a brand) and on a number of followers in a social networking platform.

The social CRM system 110 determines economic characteristics related to sharing events that resulted in actions taken with respect to the marketing message (1104). For example, a brand economic impact can be calculated, such as a return on investment that is predicted to occur if a certain dollar amount is spent on marketing to influencers who have at least a threshold brand influence score.

The social CRM system 110 generates one or more reports that reflect the impact of one or more influencers related to actions taken with respect to the marketing message and the economic characteristics related to sharing events that resulted in actions taken with respect to the marketing message (1106). The social CRM system 110 outputs the one or more generated reports (1108).

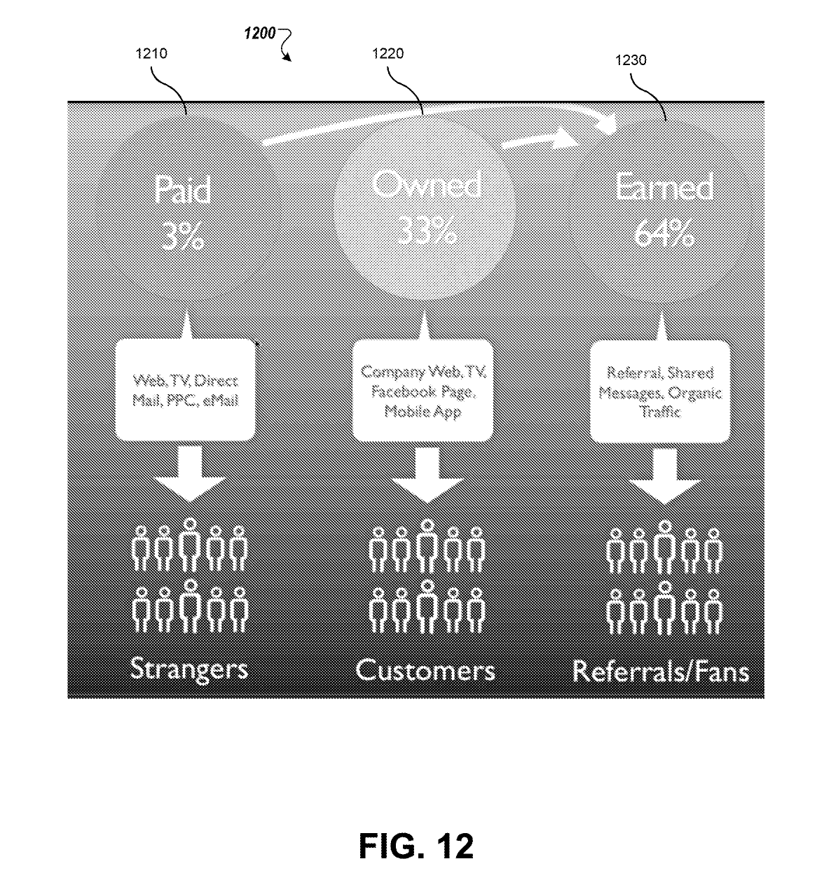

FIG. 12 illustrates an example report 1200. The report 1200 may be generated and output in performing the process 1100. The report 1200 may be generated and output by the social CRM system 110 described above with respect to FIG. 1, by the tracking server 208 described above with respect to FIG. 2, or by any type of tracking system or device that is capable of generating and outputting reports.

As shown, the report 1200 includes three sections: a paid media section 1210, an owned media section 1220, and an earned media section 1230. The paid media section 1210 includes data descriptive of marketing efforts that a company pays for from a third party. For instance, the paid media section 1210 may relate to marketing performed through web or Internet advertising (e.g., a banner advertisement, a pop-up advertisement, etc.), television advertising (e.g., television commercials), direct mail advertising (e.g., a flyer or coupon offer mailed through postal mail), pay per click advertising (e.g., preferred search results offered by a search result provider), and electronic mail advertising (e.g., offers distributed through electronic mail), or any other type of paid media. The marketing reflected in the paid media section 1210 generally is targeted at strangers that are previously unengaged with the company.

The owned media section 1220 includes data descriptive of marketing efforts that a company engages using assets the company owns. For instance, the owned media section 1220 may relate to marketing performed through a company website operated by the company, a television station owned and operated by the company, a social media page owned and operated by the company, a mobile application owned and operated by the company, or any other type of owned media that the company operates and may be used for marketing. The marketing reflected in the owned media section 1220 generally is targeted at customers that have previously engaged with the company.

The earned media section 1230 includes data descriptive of marketing that results through shared organic traffic. For instance, the earned media section 1230 may relate to marketing that results from referrals, shared messages, organic electronic communications about a company or product, or any other type of shared organic traffic that results in marketing. The earned media section 1230 may reflect the contribution of traffic generated by influencers, such as bloggers, to the marketing campaign. The marketing reflected in the earned media section 1230 generally is targeted at referrals or friends of customers that have previously engaged with the company.

The report 1200 indicates the economic impact of each of paid media, owned media, and earned media on a particular marketing campaign. As shown, the paid media section 1210 indicates that three percent of the economic value of the marketing campaign was derived through paid media, the owned media section 1220 indicates that thirty-three percent of the economic value of the marketing campaign was derived through owned media, and the earned media section 1230 indicates that sixty-four percent of the economic value of the marketing campaign was derived through earned media.

To produce the report 1200, the data described throughout this disclosure as being captured by the social CRM system 110, the tracking server 208, or any other tracking system is analyzed to determine the total economic impact of the marketing campaign, the total economic impact of paid media on the marketing campaign, the total economic impact of owned media on the marketing campaign, and the total economic impact of earned media on the marketing campaign. With the determined totals, the percentages shown in the paid media section 1210, the owned media section 1220, and the earned media section 1230 may be calculated and included in the report 1200.

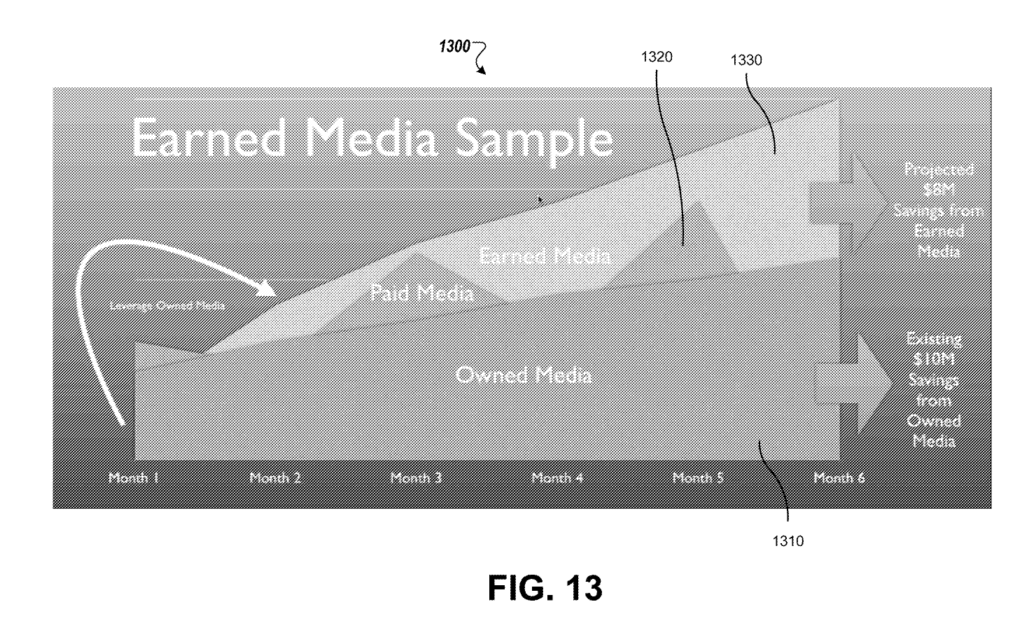

FIG. 13 illustrates an example report 1300. The report 1300 may be generated and output in performing the process 1100. The report 1300 may be generated and output by the social CRM system 110 described above with respect to FIG. 1, by the tracking server 208 described above with respect to FIG. 2, or by any type of tracking system or device that is capable of generating and outputting reports.

The report 1300 illustrates how much traffic and sales have come in through paid media, owned media, and earned media over a period of time. For example, the report 1300 includes a graph that shows how much traffic and sales have come in through paid media, owned media, and earned media over a period of six months. In this example, the x-axis of the graph shows six months in one-month increments and the y-axis shows an amount of sales in terms of dollar value (e.g., millions of dollars). As shown, the graph plots the value derived from owned media 1310, the value derived from paid media 1320, and the value derived from earned media 1330 together for a period of six months. To produce at least a portion of the value derived from earned media 1330, the owned media 1310 is leveraged to provide sharing offers or marketing messages to generate organic traffic related to the marketing campaign that is capable of being tracked. The report 1300 indicates that the data reflects an existing savings of ten million dollars from owned media and a projected savings of eight million dollars from earned media.

To produce the report 1300, the data described throughout this disclosure as being captured by the social CRM system 110, the tracking server 208, or any other tracking system is analyzed to determine the value derived from owned media 1310 for each month of the marketing campaign during the six-month period, the value derived from paid media 1320 for each month of the marketing campaign during the six-month period, and the value derived from earned media 1330 for each month of the marketing campaign during the six-month period. With the determined value amounts, the graph may be generated and included in the report 1300 to represent the value derived from each of paid, owned, and earned media.

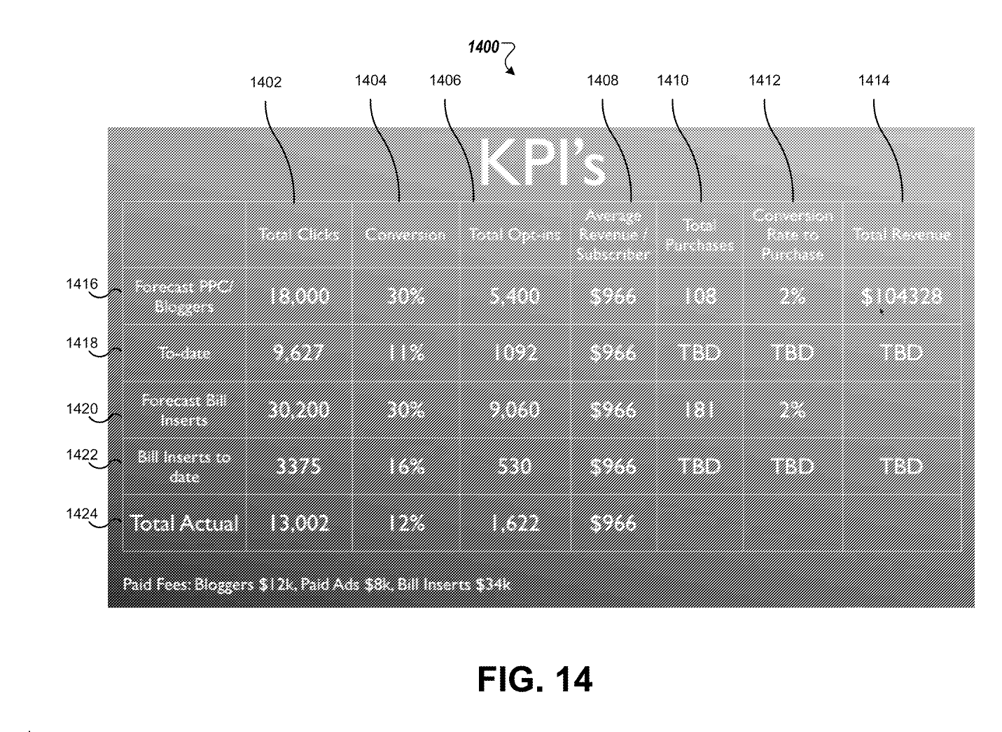

FIG. 14 illustrates an example report 1400. The report 1400 may be generated and output in performing the process 1100. The report 1400 may be generated and output by the social CRM system 110 described above with respect to FIG. 1, by the tracking server 208 described above with respect to FIG. 2, or by any type of tracking system or device that is capable of generating and outputting reports.

The report 1400 illustrates data reflective of certain key performance indicators (KPIs) of interest to a manager of a marketing campaign. As shown, the report 1400 includes a table in which each KPI of interest is presented in a column of the table. For instance, the column 1402 provides data for a Total Clicks KPI, the column 1404 provides data for a conversion percentage KPI, the column 1406 provides data for a Total Opt-ins KPI, the column 1408 provides data for an average revenue per subscriber KPI, the column 1410 provides data for a Total Purchases KPI, the column 1412 provides data for a conversion rate to purchase KPI, and the column 1414 provides data for a Total Revenue KPI.

In addition, as shown, the table includes rows that each indicate a type of marketing contact tracked for the KPIs identified in the columns 1402 to 1414. For instance, the row 1416 identifies data for a forecasted result of pay per click marketing messages shared by bloggers (or other influencers) within a social network or other online community, the row 1418 identifies data for a to-date result of pay per click marketing messages shared by bloggers (or other influencers) within a social network or other online community, the row 1420 identifies data for a forecasted result of bill insert marketing messages shared by customers (or other influencers), the row 1422 identifies data for a to-date result of bill insert marketing messages shared by customers (or other influencers), and the row 1424 identifies data for an actual total for the pay per click marketing messages shared by bloggers and the bill insert marketing messages shared by customers (or other influencers). As an example, the row 1416 illustrates that, for pay per click marketing messages shared by bloggers (or other influencers) within a social network or other online community, the calculated forecast is 18,000 total clicks of the marketing message from sharing by bloggers, a thirty percent conversion rate from the total clicks, 5,400 opt-ins related to the marketing message from sharing by bloggers, $966 for average revenue per subscriber related to the marketing message from sharing by bloggers, 108 total purchases related to the shared marketing message from sharing by bloggers, a two percent conversion rate to purchase related to the marketing message from sharing by bloggers, and $104,328 total revenue related to the marketing message from sharing by bloggers. The other rows 1418 to 1422 provide similar data for the types of marketing events tracked in the rows 1418 to 1422.

To produce the report 1400, the data described throughout this disclosure as being captured by the social CRM system 110, the tracking server 208, or any other tracking system is analyzed to determine the KPIs reflected in the columns 1402 to 1414 for each of the marketing events tracked in the rows 1418 to 1422. With the determined values for the KPIs, the table may be generated and included in the report 1400.

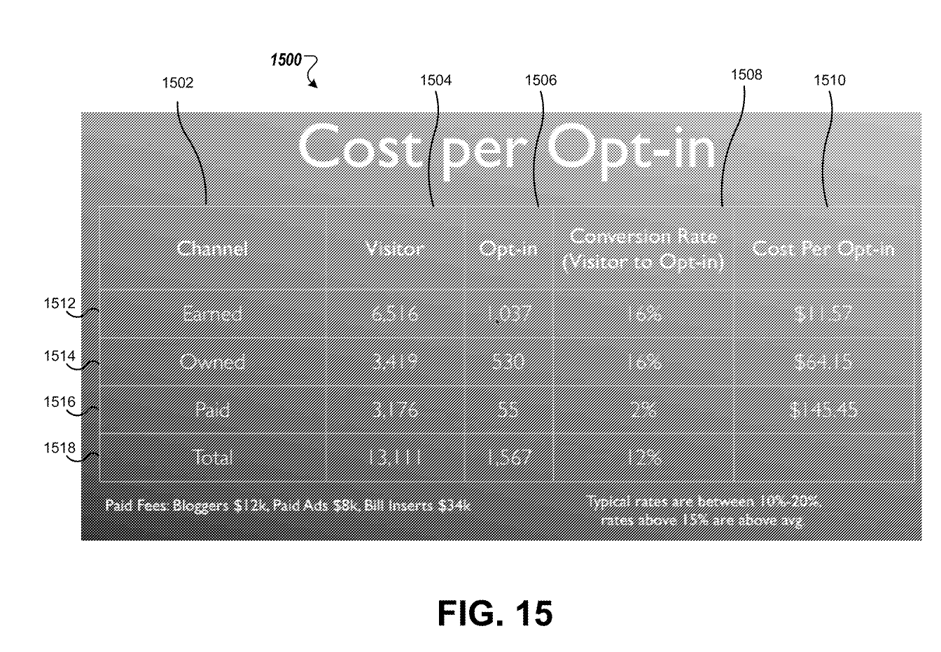

FIG. 15 illustrates an example report 1500. The report 1500 may be generated and output in performing the process 1100. The report 1500 may be generated and output by the social CRM system 110 described above with respect to FIG. 1, by the tracking server 208 described above with respect to FIG. 2, or by any type of tracking system or device that is capable of generating and outputting reports.

The report 1500 illustrates data related to costs per opt-in for a marketing campaign. As shown, the report 1500 includes a table that includes columns 1502 to 1510 and rows 1512 to 1518. The column 1502 provides data for the channel related to the cost data illustrated in the table, the column 1504 provides data for a number of visitors obtained through the channel defined in the column 1502, the column 1506 provides data for a number of opt-ins obtained through the channel defined in the column 1502, the column 1508 provides data for a conversion rate of visitors to opt-ins for the channel defined in the column 1502, and the column 1510 provides data for a cost per opt-in for the channel defined in the column 1502.

The row 1512 includes data for the earned media channel. As shown, for the earned media channel of the marketing campaign, 6,516 visitors were obtained, 1,037 opt-ins were obtained, a sixteen percent conversion from visitor to opt-in was achieved, and a cost per opt-in of $11.57 was achieved. The cost per opt-in of $11.57 was computed by dividing the total cost invested in marketing through earned media by the number of opt-ins. The row 1514 includes data for the owned media channel. As shown, for the owned media channel of the marketing campaign, 3,419 visitors were obtained, 530 opt-ins were obtained, a sixteen percent conversion from visitor to opt-in was achieved, and a cost per opt-in of $64.15 was achieved. The cost per opt-in of $64.15 was computed by dividing the total cost invested in marketing through owned media by the number of opt-ins. The row 1516 includes data for the paid media channel. As shown, for the paid media channel of the marketing campaign, 3,176 visitors were obtained, 55 opt-ins were obtained, a two percent conversion from visitor to opt-in was achieved, and a cost per opt-in of $145.45 was achieved. The cost per opt-in of $145.45 was computed by dividing the total cost invested in marketing through paid media by the number of opt-ins. The row 1518 shows a total for the visitors, opt-ins, conversion, and cost per opt-in for the marketing campaign without regard for channel.

To produce the report 1500, the data described throughout this disclosure as being captured by the social CRM system 110, the tracking server 208, or any other tracking system is analyzed to determine the number of visitors, number of opt-ins, conversion rate, and cost per opt-in reflected in the columns 1504 to 1510 for each of the channels tracked in the rows 1512 to 1518. With the determined values for the number of visitors, number of opt-ins, conversion rate, and cost per opt-in, the table may be generated and included in the report 1500.

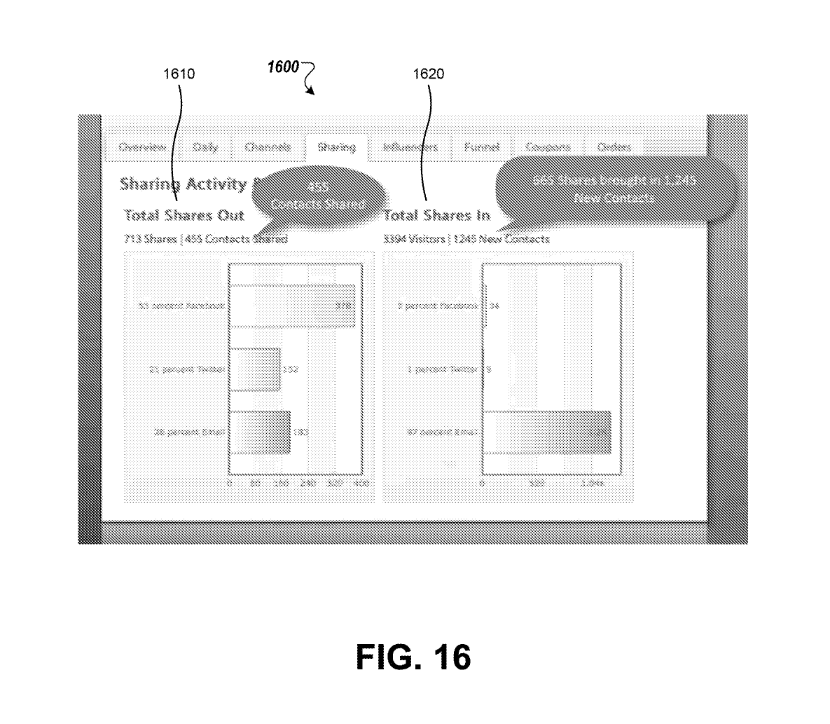

FIG. 16 illustrates an example report 1600. The report 1600 may be generated and output in performing the process 1100. The report 1600 may be generated and output by the social CRM system 110 described above with respect to FIG. 1, by the tracking server 208 described above with respect to FIG. 2, or by any type of tracking system or device that is capable of generating and outputting reports.

The report 1600 reflects sharing activity related to marketing. The report 1600 may be specific to a particular marketing message or campaign, specific to all marketing for a particular product, specific to all marketing for a particular brand, or specific to all marketing for a particular company. The report 1600 includes a sharing out section 1610 and a sharing in section 1620. The sharing out section 1610 represents data descriptive of sharing events completed by users that viewed a marketing message associated with a marketing campaign. As shown, the sharing out section 1610 indicates that 455 contacts shared the marketing message with at least one other user and a total of 713 sharing events occurred. The sharing out section 1610 also indicates fifty-three percent of the sharing events occurred through Facebook, twenty-one percent of the sharing events occurred through Twitter, and twenty-six percent of the sharing events occurred through electronic mail.

The sharing in section 1620 represents data descriptive of actions taken by users that received sharing events from other users that viewed the marketing message associated with the marketing campaign. As shown, the sharing in section 1620 indicates that 3394 users visited a website related to the marketing campaign from a sharing of the marketing message and 1245 new contacts were obtained from a sharing of the marketing message. The sharing in section 1620 also indicates three percent of the new contacts were obtained from sharing through Facebook, one percent of the new contacts were obtained from sharing through Twitter, and ninety-seven percent of the new contacts were obtained from sharing through electronic mail. The sharing in section 1630 also indicates that 665 shares of the marketing message resulted in 1,245 new contacts.

To produce the report 1600, the data described throughout this disclosure as being captured by the social CRM system 110, the tracking server 208, or any other tracking system is analyzed to determine the number of sharing users, the number of sharing events, the number of visitors from sharing events, the number of new contacts from sharing events, and the percentages related to sharing through various media platforms. With the determined values for the number of sharing users, the number of sharing events, the number of visitors from sharing events, the number of new contacts from sharing events, and the percentages related to sharing through various media platforms, the table may be generated and included in the report 1600.

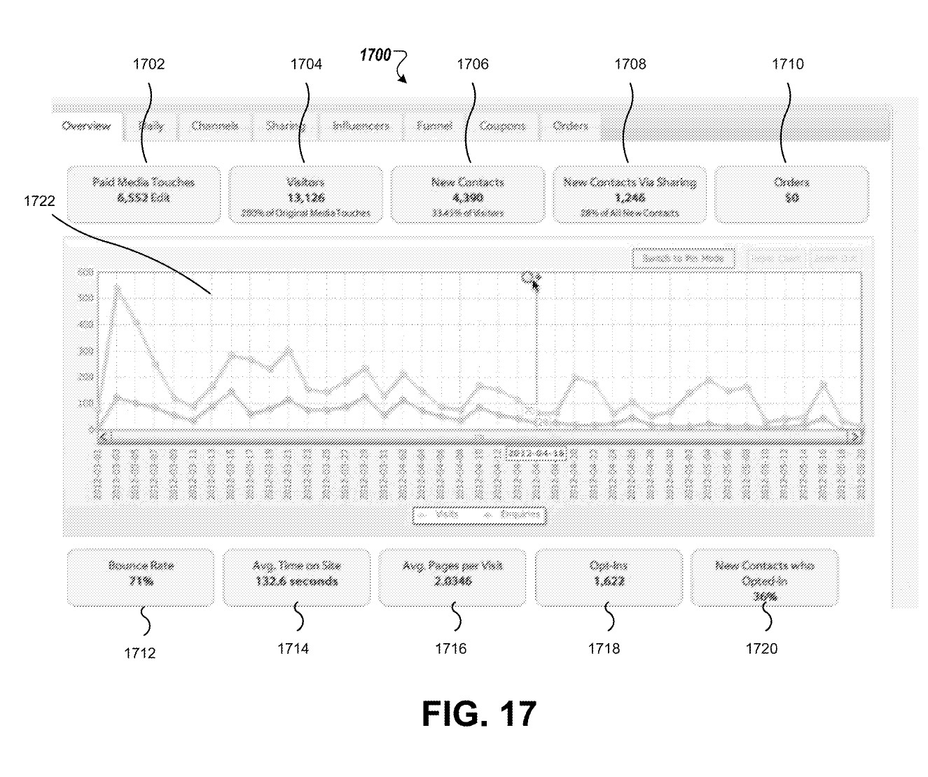

FIG. 17 illustrates an example report 1700. The report 1700 may be generated and output in performing the process 1100. The report 1700 may be generated and output by the social CRM system 110 described above with respect to FIG. 1, by the tracking server 208 described above with respect to FIG. 2, or by any type of tracking system or device that is capable of generating and outputting reports.

The report 1700 provides an overview of data and statistics gathered through tracking of a marketing campaign. The report 1700 includes a field 1702 that indicates a number of paid media touches received for the marketing campaign and a field 1704 that indicates a number of visitors received for the marketing campaign. The report 1700 also includes a field 1706 that indicates a number of new contacts received for the marketing campaign, a field 1708 that indicates a number of new contacts received for the marketing campaign through sharing, and a field 1710 that indicates a dollar value of orders resulting from the marketing campaign. The report 1700 further includes a field 1712 that indicates a bounce rate for the marketing campaign, a field 1714 that indicates an average time on site for visitors of a website related to the marketing campaign, and a field 1716 that indicates an average number of pages per visit for visitors of a website related to the marketing campaign. In addition, the report 1700 further includes a field 1718 that indicates a number of opt-ins resulting from the marketing campaign, a field 1720 that indicates a number of new contacts that opted-in to the marketing campaign, and a graph 1722 that plots a number of visits and a number of enquiries received for the marketing campaign over a period of time.

To produce the report 1700, the data described throughout this disclosure as being captured by the social CRM system 110, the tracking server 208, or any other tracking system is analyzed to determine the data values for the fields 1702 to 1720 and the graph 1722. With the determined values for the fields 1702 to 1720 and the graph 1722, the report 1700 may be generated.

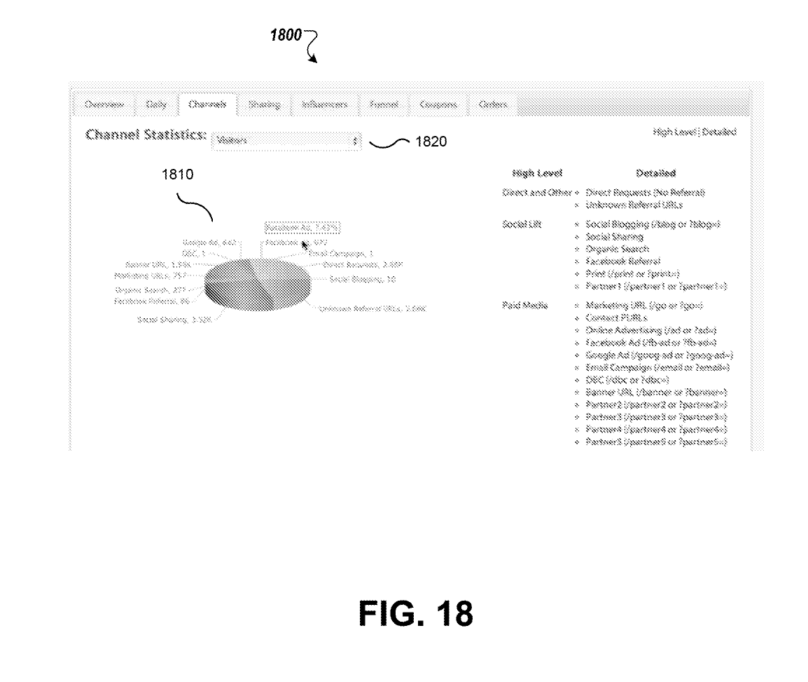

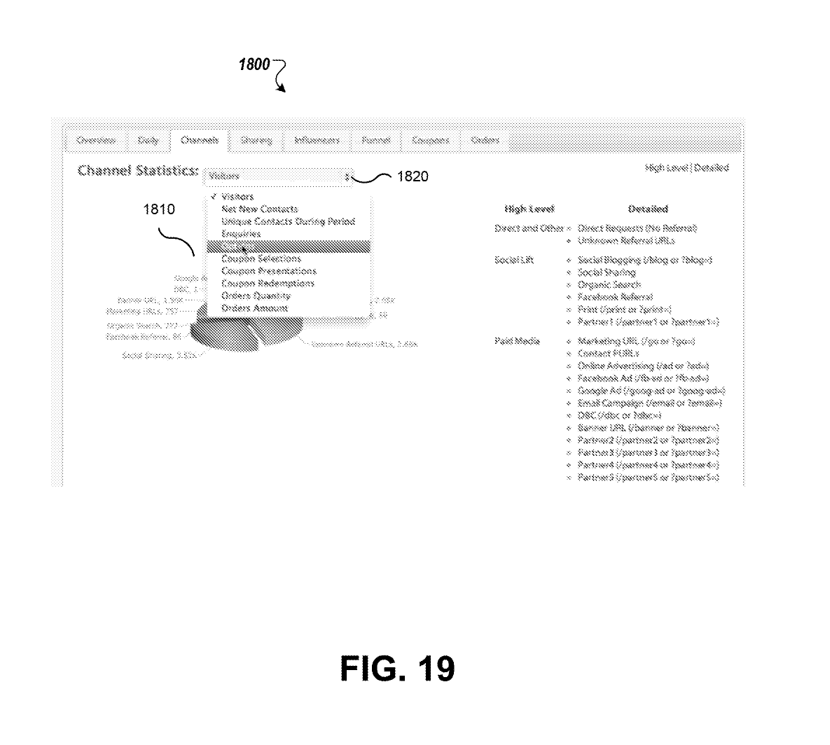

FIGS. 18 and 19 illustrate an example report 1800. The report 1800 may be generated and output in performing the process 1100. The report 1800 may be generated and output by the social CRM system 110 described above with respect to FIG. 1, by the tracking server 208 described above with respect to FIG. 2, or by any type of tracking system or device that is capable of generating and outputting reports.

The report 1800 reflects the impact of various different channels on the marketing campaign. The report 1800 includes a channel data section 1810 and a data selection control 1820. The channel data section 1810 represents data descriptive of events that have occurred through the various channels in a marketing campaign. As shown in FIG. 18, the channel data section 1810 provides data related to a number of visitors obtained through each of the various channels in a marketing campaign. For instance, the channel data section 1810 indicates the number of visitors and/or percentage of visitors obtained from a Google advertisement, the number of visitors and/or percentage of visitors obtained from a Facebook advertisement, the number of visitors and/or percentage of visitors obtained from an email campaign, the number of visitors and/or percentage of visitors obtained from direct requests, the number of visitors and/or percentage of visitors obtained from social blogging, the number of visitors and/or percentage of visitors obtained from unknown referral URLs, the number of visitors and/or percentage of visitors obtained from social sharing, the number of visitors and/or percentage of visitors obtained from Facebook referrals, the number of visitors and/or percentage of visitors obtained from organic searching, the number of visitors and/or percentage of visitors obtained from marketing URLs, the number of visitors and/or percentage of visitors obtained from banner URLs, and the number of visitors and/or percentage of visitors obtained from DBC advertising.

The data selection control 1820 enables a user to select which type of data the user desires to view in the channel data section 1810. For example, as shown in FIG. 19, the data selection control 1820 enables a user to select to view statistics on visitors, net new contacts, unique contacts during a period, enquiries, opt-ins, coupon selections, coupon presentations, coupon redemptions, orders quantity, and orders amount.

To produce the report 1800, the data described throughout this disclosure as being captured by the social CRM system 110, the tracking server 208, or any other tracking system is analyzed to determine data values for the type of event selected using the data selection control 1820 broken down by type of channel. With the determined values for the type of event selected using the data selection control 1820 broken down by type of channel, the channel data section 1810 may be generated and included in the report 1800.

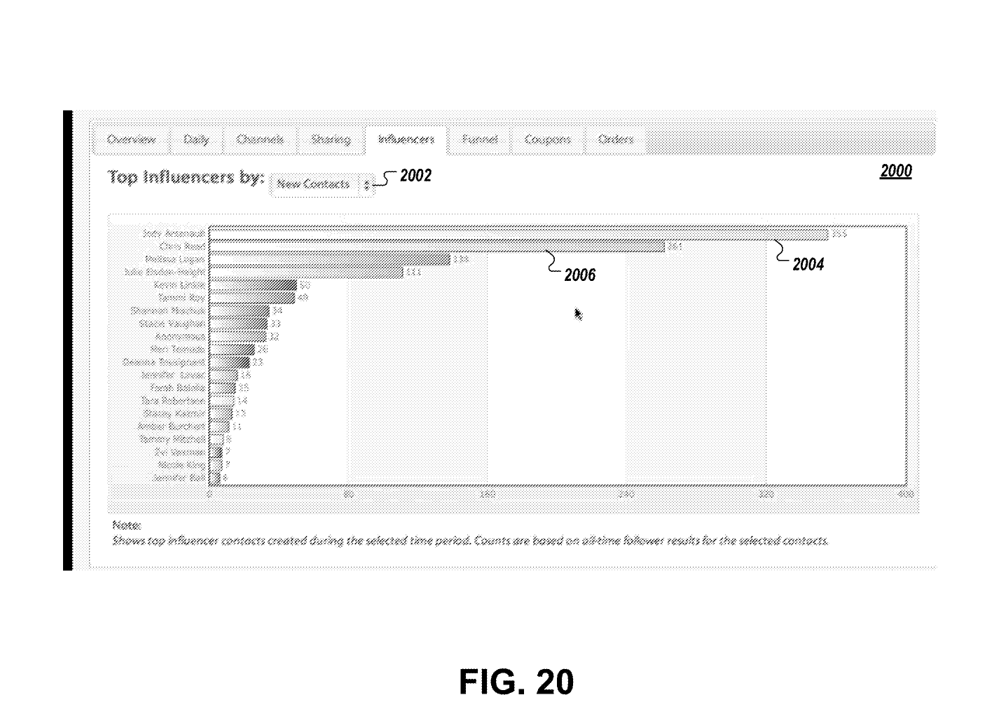

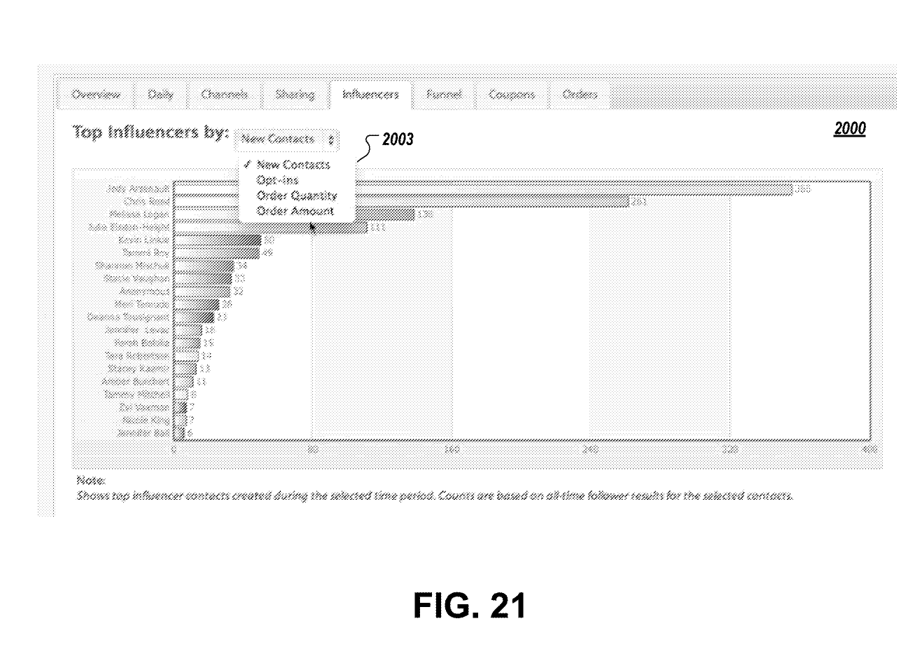

FIGS. 20 and 21 illustrate an example report 2000. The report 2000 may be generated and output in performing the process 1100. The report 2000 may be generated and output by the social CRM system 110 described above with respect to FIG. 1, by the tracking server 208 described above with respect to FIG. 2, or by any type of tracking system or device that is capable of generating and outputting reports.

The report 2000 includes data for top influencers for an organization. For example, the report 2000 currently displays top influencers by number of generated contacts, as indicated by a control 2002. The user of the report 2000 can use the control 2002 to select another criteria for which to view top influencers. For example, as shown in an expanded control 2003 in FIG. 21, the user can select a criterion of number of opt-ins, order quantity, or order amount. In some implementations, a time period can be configured to display top influencers for a particular time period, for a category selected using the control 2003.

Referring again to FIG. 20, the report 2000 indicates, for example, that an influencer 2004 named Jody Arsenault is a top influencer, with 355 contacts. That is, during a particular time frame (e.g., the past six months), Jody generated 355 new contacts for the organization as a result of Jody sharing marketing messages and receivers viewing such messages. As another example, the report 2000 indicates that an influencer 2006 named Chris Read is a second top influencer, according to number of generated contacts. Additional detail for an influencer can be displayed for an influencer by selecting (e.g., double clicking) on an influencer row in the report 2000. To produce the report 2000, the data described throughout this disclosure as being captured by the social CRM system 110, the tracking server 208, or any other tracking system is analyzed to identify a set of top influencers according to a selected criterion.

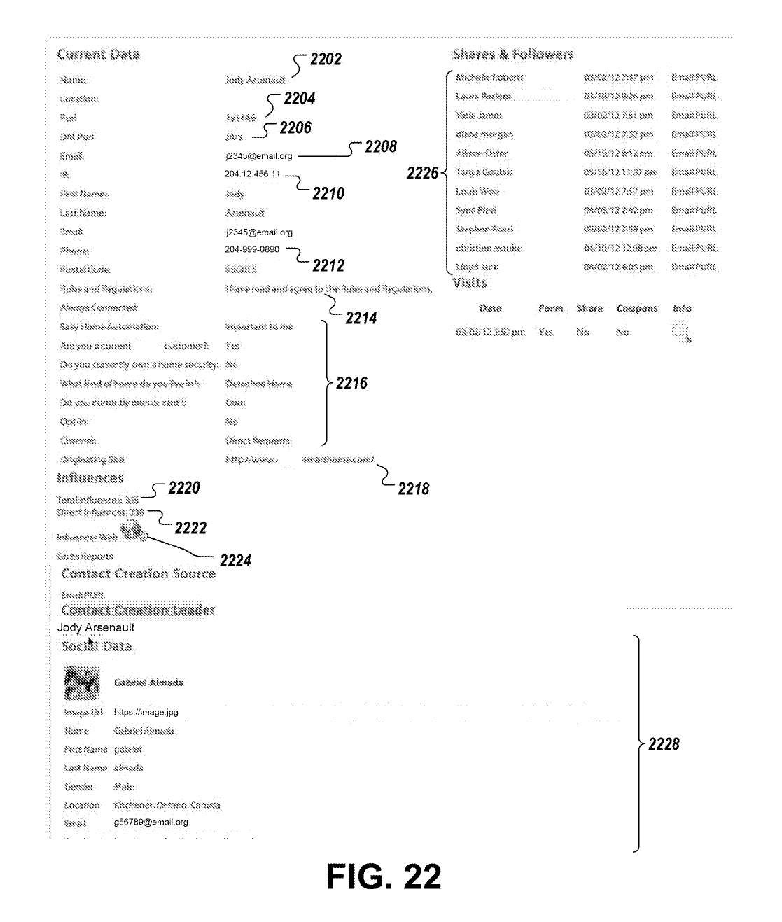

FIG. 22 illustrates an example report 2200. The report 2200 may be generated and output in performing the process 1100. The report 2200 may be generated and output by the social CRM system 110 described above with respect to FIG. 1, by the tracking server 208 described above with respect to FIG. 2, or by any type of tracking system or device that is capable of generating and outputting reports. To produce the report 2200, the data described throughout this disclosure as being captured by the social CRM system 110, the tracking server 208, or any other tracking system is analyzed to determine information specific to a particular influencer. The report 2200 can be displayed, for example, in response to selection of an influencer displayed on the report 2000 discussed above with reference to FIG. 20.

The report 2200 displays, for a particular influencer, a name 2202, an influencer identifier 2204 (e.g., “personal URL”, or “PURL”), a direct mail influencer identifier 2206, an email address 2208, an IP (Internet Protocol) address 2210, and a phone number 2212. Some or all of such information can be obtained from the influencer when the influencer opts in to the social CRM system 110. The IP address 2210 can be an IP address of a user device used to opt in to the social CRM system 110. A rules and regulations indicator 2214 can indicate that the influencer accepted rules and regulations displayed in an opt-in user interface. Influencer survey answers 2216 can be included for an influencer, where the survey answers may have been obtained during an opt-in process or at some other time. An originating site address 2218 indicates a web site address from which the influencer accessed an opt-in interface.

A total influences indicator 2220 can be included, which indicates a total number of actions taken by other users in response to sharing of marketing messages by the influencer, including actions taken by other users in response to the influencer sharing a marketing message, another influencer subsequently re-sharing that message, and yet another influencer taking some action in response to the re-shared message. A direct influences indicator 2222 can be included, which indicates actions taken directly by users who received a marketing message directly from the influencer. For example, out of 355 total influences attributed to the influencer, 338 of those influences were performed by other users who received a marketing message directly from the influencer.

A report that displays details about actions taken by users related to the influencer can be displayed by selecting a control 2224. A shares and followers section 2226 can display a list of users who have received a share of a marketing message from the influencer and/or who are a follower of the influencer in a social networking platform. If the influencer opted in to the social CRM system 110 as a result of responding to a message shared by another user, a section 2228 can display information about the user who shared the message with the influencer.

A number of methods, techniques, systems, and apparatuses have been described. Nevertheless, various modifications may be made without departing from the scope of this disclosure. For example, although various techniques generally are disclosed herein as being performed externally to an electronic social networking platform, in some implementations, the various techniques disclosed herein may be performed internally by an electronic social networking platform.

The methods, techniques, systems, and apparatuses described herein may be implemented in digital electronic circuitry or computer hardware, for example, by executing instructions stored in tangible computer-readable storage media. Apparatuses implementing these techniques may include appropriate input and output devices, a computer processor, and/or tangible computer-readable storage media storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, in some implementations, individual operations may be rearranged in a different order, combined with other operations described herein, and/or eliminated, and the desired results still may be achieved. Similarly, components in the disclosed systems may be combined in a different manner and/or replaced or supplemented by other components and the desired results still may be achieved.

A number of implementations have been described. Nevertheless, it will be understood that various modifications may be made without departing from the spirit and scope of the disclosure. Accordingly, other implementations are within the scope of the following claims.

What is claimed is:

1. A system comprising:
at least one processor; and
at least one computer-readable medium coupled to the at least one processor having stored thereon instructions which, when executed by the at least one processor, causes the at least one processor to perform operations comprising:
distributing, to an influencer, a marketing message related to a good or service;
receiving, from the influencer, an agreement to allow tracking of the influencer's sharing of the marketing message;
after receiving the agreement to allow tracking of the influencer's sharing of the marketing message, enabling sharing of the marketing message in a manner that enables tracking of actions taken by users to which the marketing message is shared;
tracking sharing of the marketing message by the influencer;
tracking actions related to the marketing message taken by users to which the message was shared by the influencer;
storing data descriptive of an influence of the influencer related to the marketing message; and
providing output based on the stored data.

2. The system of claim 1, wherein receiving, from the influencer, the agreement to allow tracking of the influencer's sharing of the marketing message comprises validating the influencer to ensure the influencer opts in and agrees to corporate and governmental privacy statements.

3. The system of claim 2, wherein validating the influencer comprises presenting, to the influencer, an inducement to encourage the influencer to opt in and agree to the corporate and governmental privacy statements.

4. The system of claim 3, wherein presenting, to the influencer, the inducement comprises presenting, to the influencer, at least one of a free product, a leaderboard score, and a prize in exchange for opting in and agreeing to the corporate and governmental privacy statements.

5. The system of claim 1, wherein enabling sharing of the marketing message in a manner that enables tracking of actions taken by users to which the marketing message is shared comprises enabling sharing of the marketing message through at least one of a social network, a text message, an instant message, and an electronic mail message.

6. The system of claim 1, wherein enabling sharing of the marketing message in a manner that enables tracking of actions taken by users to which the marketing message is shared comprises:
determining a message identifier for the marketing message;
determining an influencer identifier for the influencer;
generating a sharing identifier based on the message identifier and the influencer identifier;
embedding the sharing identifier in data that transmits with the marketing message in sharing the marketing message;
enabling the influencer to share the marketing message with the embedded sharing identifier.

7. The system of claim 6:
wherein generating the sharing identifier based on the message identifier and the influencer identifier comprises dynamically generating a unique uniform resource locator (URL) that includes the message identifier and the influencer identifier, and
wherein embedding the sharing identifier in data that transmits with the marketing message in sharing the marketing message comprises placing the dynamically-generated unique URL in the marketing message.

8. The system of claim 1, wherein tracking sharing of the marketing message by the influencer comprises:
receiving, over a network, an indication of sharing of the marketing message by the influencer; and
tracking sharing of the marketing message by the influencer based on receiving the indication of sharing of the marketing message by the influencer.

9. The system of claim 8:
wherein receiving, over the network, the indication of sharing of the marketing message by the influencer comprises receiving, over a network from a social networking platform, an indication that the influencer shared the marketing message within the social networking platform and an indication of one or more users of the social networking platform to which the influencer shared the marketing message; and
wherein tracking sharing of the marketing message by the influencer based on receiving the indication of sharing of the marketing message by the influencer comprises tracking sharing of the marketing message by the influencer based on receiving the indication that the influencer shared the marketing message within the social networking platform and the indication of the one or more users of the social networking platform to which the influencer shared the marketing message.

10. The system of claim 1, wherein tracking actions related to the marketing message taken by users to which the message was shared by the influencer comprises:
detecting an action of a user related to the marketing message;
accessing data descriptive of one or more sharing events that resulted in the user receiving the marketing message;
linking the one or more sharing events with the detected action of the user; and
tracking the detected action of the user in association with the one or more sharing events and the marketing message.

11. The system of claim 10:
wherein detecting the action of the user related to the marketing message comprises detecting at least one of a view of the marketing message, an opt-in related to the marketing message, and a purchase related to the marketing message; and
wherein tracking the detected action of the user in association with the one or more sharing events and the marketing message comprises tracking the at least one of the view of the marketing message, the opt-in related to the marketing message, and the purchase related to the marketing message in association with the one or more sharing events and the marketing message.

12. The system of claim 11:
wherein detecting the action of the user related to the marketing message comprises receiving, over a network from a merchant server of a merchant, an indication that the user made, from the merchant, a purchase related to the marketing message; and
wherein tracking the detected action of the user in association with the one or more sharing events and the marketing message comprises tracking the purchase related to the marketing message in association with the one or more sharing events and the marketing message.

13. The system of claim 11:
wherein accessing data descriptive of one or more sharing events that resulted in the user receiving the marketing message comprises accessing, from electronic storage on a device of the user, a data file that records the one or more sharing events that resulted in the user receiving the marketing message; and
wherein linking the one or more sharing events with the detected action of the user comprises extracting, from the data file, the one or more sharing events that resulted in the user receiving the marketing message and linking the one or more sharing events extracted from the data file with the detected action of the user.

14. The system of claim 11:
wherein accessing data descriptive of one or more sharing events that resulted in the user receiving the marketing message comprises accessing data descriptive of a sharing event that indicates a sharing user that directly shared the marketing message with the user; and
wherein linking the one or more sharing events with the detected action of the user comprises linking, with the detected action of the user, the sharing event that indicates the sharing user that directly shared the marketing message with the user.

15. The system of claim 11:
wherein accessing data descriptive of one or more sharing events that resulted in the user receiving the marketing message comprises accessing data descriptive of a first sharing event that indicates a first sharing user that directly shared the marketing message with the user and a second sharing event that indicates a second sharing user that directly shared the marketing message with the first sharing user; and
wherein linking the one or more sharing events with the detected action of the user comprises linking, with the detected action of the user, the first sharing event that indicates the first sharing user that directly shared the marketing message with the user and the second sharing event that indicates the second sharing user that directly shared the marketing message with the first sharing user.

16. The system of claim 1, wherein providing output based on the stored data comprises:
determining an impact of one or more influencers related to actions taken with respect to the marketing message;
generating one or more reports that reflect the impact of one or more influencers related to actions taken with respect to the marketing message; and
outputting the one or more generated reports.

17. The system of claim 1, wherein providing output based on the stored data comprises:
determining economic characteristics related to sharing events that resulted in actions taken with respect to the marketing message;
generating one or more reports that reflect the economic characteristics related to sharing events that resulted in actions taken with respect to the marketing message; and
outputting the one or more generated reports.

18. The system of claim 1, wherein providing output based on the stored data comprises:
determining an impact of one or more influencers related to actions taken with respect to the marketing message;
determining economic characteristics related to sharing events that resulted in actions taken with respect to the marketing message;
generating one or more reports that reflect the impact of one or more influencers related to actions taken with respect to the marketing message and the economic characteristics related to sharing events that resulted in actions taken with respect to the marketing message; and
outputting the one or more generated reports.

19. At least one computer-readable storage medium encoded with executable instructions that, when executed by at least one processor, cause the at least one processor to perform operations comprising:
distributing, to an influencer, a marketing message related to a good or service;
receiving, from the influencer, an agreement to allow tracking of the influencer's sharing of the marketing message;
after receiving the agreement to allow tracking of the influencer's sharing of the marketing message, enabling sharing of the marketing message in a manner that enables tracking of actions taken by users to which the marketing message is shared;
tracking sharing of the marketing message by the influencer;
tracking actions related to the marketing message taken by users to which the message was shared by the influencer;
storing data descriptive of an influence of the influencer related to the marketing message; and
providing output based on the stored data.

20. A method comprising:
distributing, to an influencer, a marketing message related to a good or service;
receiving, from the influencer, an agreement to allow tracking of the influencer's sharing of the marketing message;
after receiving the agreement to allow tracking of the influencer's sharing of the marketing message, enabling sharing of the marketing message in a manner that enables tracking of actions taken by users to which the marketing message is shared;
tracking sharing of the marketing message by the influencer;
tracking actions related to the marketing message taken by users to which the message was shared by the influencer;
storing, in electronic storage, data descriptive of an influence of the influencer related to the marketing message; and
providing, by at least one processor, output based on the stored data.
